(19) United States
(12) Patent Application Publication
(10) Pub. No.: US 2001/0038963 A1
(43) Pub. Date: Nov. 8, 2001

(54) Electrostatic image developing toner employing a metal complex

(75) Inventors: Shinji Otani, Tsukuba-shi (JP); Yutaka Saito, Tsukuba-shi (JP); Hieyuki Otsuka, Tsukuba-shi (JP); Masataka Sawano, Tsukuba-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Hodogaya Chemical Co., Ltd., Kawasaki-shi (JP)

(21) Appl. No.: 09/837,275

(22) Filed: Apr. 19, 2001

Related U.S. Application Data
(62) Division of application No. 09/516,360, filed on Mar. 1, 2000.

(30) Foreign Application Priority Data
Mar. 11, 1999 (JP) 1-107000
Jun. 18, 1999 (JP) 11-172715

(51) Int. Cl. G03G 9/097

(52) U.S. Cl. 430/124; 430/125; 430/108.3; 430/108.24; 430/109.4

(57) ABSTRACT

An electrostatic image developing toner to be used for an image forming method wherein in an electrophotographic process of forming an electrostatic latent image on a photoreceptor made of an inorganic or organic material, developing it with a toner, transferring it to a paper sheet, a plastic film or the like, and fixing it to form a visible image, the toner remaining on the photoreceptor after the transfer, is recovered, and the recovered toner is reused in the development process, said electrostatic image developing toner comprising at least a binder resin, a colorant and a charge control agent, wherein the charge control agent is represented by the following formula (1);

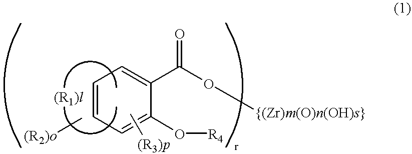

wherein R₁ is quaternary carbon, methine or methylene and may contain a hetero atom of N, S, O or P, each of R₂ and R₃ which are independent of each other, is an alkyl group, an alkenyl group, an alkoxy group, an aryl, aryloxy, aralkyl or aralkyloxy group which may have a substituent, a halogen atom, a hydrogen atom, a hydroxyl group, an amino group which may have a substituent, a carboxyl group, a carbonyl group, a nitro group, a nitroso group, a sulfonyl group or a cyano group, R₄ is a hydrogen atom or an alkyl group, l is an integer of from 0 to 12, m is an integer of from 1 to 20, n is an integer of from 0 to 20, o is an integer of from 0 to 4, p is an integer of from 0 to 4, r is an integer of from 1 to 20, and s is an integer of from 0 to 20.

The present invention relates to an electrostatic image developing toner useful for developing an electrostatic latent image in the field of electrophotographic or electrostatic recording materials. More particularly, it relates to an electrostatic image-developing toner to be used in an image forming apparatus whereby a non-transferred toner after the transfer is recovered by a cleaning process and refused by recycling. Further, it relates to an electrostatic image developing toner having an excellent electrification rising property and electrification stability.

In an image forming process by an electrophotographic system, an electrostatic latent image is formed on a photoreceptor made of an inorganic or organic material, and the latent image is developed by a toner, then transferred to a paper sheet, a plastic film or the like and fixed to obtain a visible image. The photoreceptor is positively electrifiable or negative electrifiable depending upon its construction. When a printed portion is to be retained as an electrostatic latent image by exposure, development is carried out by means of an inversely electrifiable toner. On the other hand, when reversal development is to be carried out by removing electrification of a printed portion, development is carried out by means of a toner electrifiable with the same code of electricity.

In the above process, the toner on the photoreceptor will not be all transferred, and a non-transferred toner will remain at a level of from 5 to 20 wt %. Such a non-transferred toner is usually recovered by e.g. a step of scraping by a cleaning blade and collected as a waste toner. However, with such a waste toner, various properties such is as electrification properties or resin properties are substantially changed as compared with a fresh toner, and it used to be usually impossible to reuse such a waste toner.

In recent years, along with an increase in demand for printers and copying machines, consumption of toners has remarkably increased, and at the same time, the amount of waste materials discharged from electrophotographic processes has likely increased. In vies of adverse effects to the environment of such waste materials, it has been proposed to reuse waste toners. for example, JP-A-1-214874 proposes a toner using, as a binder resin, a specific polyester resin containing an aliphatic diol, or JP-A-2-110572 proposes a toner wherein a metal-crosslinked styrene/acrylic copolymer is used as a binder resin, and a large amount of a polyolefin is added thereto. However, in either case, the elements constituting the toner are restricted, and there is an additional problem such that the storage stability tends to deteriorate. Further, JP-A-7-301954 proposes to reuse a waste toner with respect to a toner containing, as a charge control agent, an azo type iron complex compound, However, also in the case of a toner employing such a charge control agent, it is impossible to obtain a recovered toner having a performance equal to the fresh toner, since a decrease in the amount of the charge control agent in the recovered waste toner or broadening of the electrification distribution will occur, and problems have not completely been solved. Further, such a charge control agent has a color and thus has had a problem that it can not be used for a color toner which is also increasingly demanded in recent years.

Further, for example, in the case of a two component development, in order to impart an adequate tribocharge to the developer, it is necessary to drive the developing section for a predetermined period of time during operation of the system, to obtain a tribocharge required for the development process. Usually, it takes a few minutes as a time for this preparation till the first copy. In recent years, from the viewpoint of energy saving, it is common to adopt a system in which a printer or a copying machine which is not used for a certain period of time, is maintained in a system standby state, and at the time of initiating printing, the developing section is driven again to obtain a tribocharge. Accordingly, it is desired that the time till the developer obtains the necessary tribocharge is as short as possible, but in reality, it is not necessarily possible to obtain an adequate initial tribocharge.

Further, in recent years, it is common to employ a mono component development for e.g. small-size printers. In such a case, it is required to complete the electrification step of the toner in a very short time. For this purpose, it has been proposed to apply a DC voltage during development to inject an electrical charge or to improve the fluidity by adding e.g. silica to improve the rising of the initial electrification. However, by the method of injecting the electrical charge, it is necessary to carry out very delicate adjustment of the bias for development, and there has been a problem that the apparatus tends to be expensive, or the electrification can not be maintained and will decrease, whereby it has been often observed that the toner remaining after the transfer increases or an image defect such as fogging results. On the other hand, by the use of a superplasticizing agent, the apparent rising of electrification will be improved, but this is attributable to the fact that the agent which is fine particles, is strongly charged, and the electrification of the toner itself remains to be low. Accordingly, problems may happen such that the highly electrified agent selectively remains on the developing parts or on the photoreceptor. Thus, this method has not been a method effective to improve the rising of electrification.

As a toner to be used for such developing methods, it has been common to employ a fine powder having a colorant dispersed in a resin. For example, in the case of a non-magnetic toner, a colorant such as carbon black is. dispersed in a binder resin such as a styrene/acrylic copolymer resin, followed by pulverization and classification to obtain fine particles of from about 1 to 30 μm, which are used as a toner. Further, as a magnetic toner, it is common to employ one having e.g. magnetite incorporated as a colorant.

A dry development method to be used for such electrophotography may generally be classified into a two component development and a mono component development. The system employing a mono component development has a merit that the developing apparatus may be made small-sized, but as compared with the two component development, the electrostatic image developing toner is required to gain a predetermined quantity of electrification in a short period of time, whereby it used to have problems that a limited material must be used, and the design allowance of the developing system is very narrow. On the other hand, the two component development is excellent in the electrification control, but has had a problem that the apparatus tends to be complex and large-sized.

In order for such an electrostatic developing toner to gain a desired level of tribocharge, it has heretofore been known to incorporate a certain charge control agent to the toner. However, such a charge control agent usually has a nature to soil a toner carrier such as a developing roller, whereby the tribocharge tends to remarkably decrease by repeated printing operation over a long period of time, thus leading to problems of image defects such as a decrease in the image density, background fogging and scattering in the machine. In order to maintain a constant clear image in repeated printing operation for a long period of time, it is not sufficient to merely stabilize the tribocharge, and it is necessary to take the magnetic properties of the toner into consideration, The magnetic properties of magnetic toners are reported, for example, in JP-A-58-95748, JP-A-58-98744 and JP-A-6-332240.

JP-A-58-95748 discloses that saturation magnetization is influential over transportability of the magnetic toner particles. Namely, when the saturation magnetization is lower than a certain level, the magnetization transporting force decreases, thereby leading to uneven development. On the other hand, if the saturation magnetization is higher than a certain level, the amount of the magnetic powder necessarily increases, whereby the fixing property or the developing property tends to deteriorate. Whereas, if the coercive force is lower than a certain level, development failure tends to result, and if it is higher than a certain level, coagulation of toner particles increases, thus leading to a decrease in transportability.

JP-A-6-332240 discloses that stability of an image for a long period of time can be obtained when there is no change in the particle size of the toner, and that in such a case, it is important to maintain the balance of the tribocharge and the magnetic properties by using a certain specific charge control agent.

As a means to solve such problems, certain chromium compounds have been proposed in JP-B-43-17955, JP-B-55-42752 and 7P-B-63-1994. By using such charge control agents, it is certainly possible to maintain the constant effect for controlling electrification and to produce a clear image even in repeated printing operation for a long period of time. However, there has been a problem from the viewpoint of environmental safety, since the compounds are chromium compounds.

JP-A-6-332240 proposes a negatively electrifiable charge control agent of an iron compound taking safety into consideration against the above chromium compounds. However, with such an iron compound, the initial rising of electrification and saturated tribocharge are not comparable to the effects obtainable by the above chromium compounds, and it has been difficult to obtain an adequate performance in a mono component development. Under these circumstances, it has been desired to develop a charge control agent which is safe and excellent in the electrification controlling performance for a long period of time.

It is an object of the present invention to provide an electrostatic image developing toner having the above-described problems solved, i.e. an electrostatic image developing toner suitable for reuse by recycling.

Namely, it is an object of the present invention to provide an electrostatic image developing toner which is capable of obtaining a clear image having an adequate image density free from background fogging or scattering of the toner in the machine, in any environment in an electrophotographic system capable of recycling. Further, it is intended to obtain a similar clear image also in a recycling system of a color toner, for which the demand has been rapidly increasing in recent years.

Further, another object of the present invention is to provide an electrostatic image developing toner which is excellent in the rising of electrification and has electrification stability for a long period of time.

Namely, the present invention is to provide an electrostatic image developing toner which is capable of obtaining a clear image having a sufficient imager density from the first print, without background fogging or scattering of the toner in the machine and which is capable of maintaining the clear image for a long period of time, in an electrophotographic system.

Further, another object of the present invention is to provide an electrostatic image developing toner which is capable of forming a clear image by maintaining a constant electrification controlling effect even in repeated printing operation for a long period of time and is free from a problem from the viewpoint of environmental safety and which has an excellent electrification rising property and electrification stability.

To present an electrostatic image developing toner suitable for recycling, the present invention provides an electrostatic image developing toner to be used for an image forming method wherein in an electrophotographic process of forming an electrostatic latent image on a photoreceptor made of an inorganic or organic material, developing it with a toner, transferring it to a paper sheet, a plastic film or the like, and fixing it to form a visible image, the toner remaining on the photoreceptor after the transfer, is recovered, and the recovered toner is reused in the development process, said electrostatic image developing toner comprising at least a binder resin, a colorant and a charge control agent, wherein the charge control agent is represented by the following formula (1):

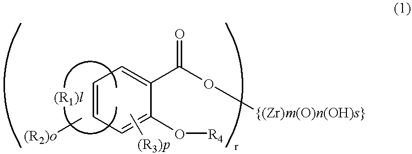

wherein R₁ is quaternary carbon, methine or methylene and may contain a hetero atom of N. S, O or P, each of R₂ and R₃ which are independent of each other, is an alkyl group, an alkenyl group, an alkoxy group, an aryl, aryloxy, aralkyl or aralkyloxy group which may have a substituent, a halogen atom, a hydrogen atom, a hydroxyl group, an amino group which may have a substituent, a carboxyl group, a carbonyl group, a nitro group, a nitroso group, a sulfonyl group or a cyano group, R₄ is a hydrogen atom or an alkyl group, l is an integer of from 0 to 12, m is an integer of from 1 to 20, n is an integer of from 0 to 20, o is an integer of from 0 to 4, p is an integer of from 0 to 4, r is an integer of from 1 to 20, and s is an integer of from 0 to 20.

Along with a remarkable increase in demand of an electrostatic image developing toner for printers and copying machines in recent years, the amount of a waste toner to be recovered has been substantially increasing.

Such a waste toner is usually recovered from a cleaning process, stored in a waste toner box and then discharged from the system. Such a waste toner can not be reused, because if it is supplied again to the developing section and used for development, there will be problems such as a decrease in the image density, an increase of fogging and soiling in the machine due to scattering of the toner.

To investigate the causes for such problems, the present inventors have measured various physical properties of a fresh toner and a waste toner. As a result, it has been ascertained that with a toner having such problems, the amount of the charge control agent contained in the toner, which should be at the same level as in a fresh toner, is substantially decreased in the waste toner. Further, with respect to both toners, the electrification distributions were measured, and it has been found that as compared with the fresh toner, with the waste toner, the proportion of an inversely electrified toner is increased, and the electrification distribution is broadened.

Namely, the cause for the above-mentioned image deterioration and soiling in the machine, is considered to be such that in the transfer process, among developing toner particles on the photoreceptor, only sufficiently electrified toner particles will be selectively transferred, is and weakly or inversely electrified toner particles will remain as a non-transferred toner on the photoreceptor and will be recovered in a cleaning process, whereby the electrification distribution of the recovered toner tends to be broadened, and the proportion of inversely electrified toner particles tends to increase.

The reason for such selective transfer is considered to be such that in a fresh toner, toner particles having a small proportion of a charge control agent are already present, and such toner particles having a small proportion of a charge control agent will selectively remain during the transfer and will be recovered, since with such toner particles, no adequate tribocharge will be obtained. This is evident also from the fact that the content of the charge control agent in a recovered toner is rather low.

To solve such problems, the present inventors have conducted an extensive study and as a result, have found it very effective to employ the compound of the above formula (1) as a charge control agent in a toner to be used for a recycling system for a waste toner.

The compound is also thermally stable and is not susceptible to a thermal change during the electrophotographic process, whereby a stabilized electrification property can be maintained. Further, it can be uniformly dispersed in any binder resin, and thus presents a feature that the electrification distribution of a fresh toner is very uniform. Further, the content of the compound in the non-transferred recovered toner was analyzed and found to be the same content as in the fresh toner, and the saturated tribochange and electrification distribution were also found to be the same.

To present an electrostatic image-developing toner which is excellent in the electrification rising and which has an electrification stabilty for a long period of time, the present invention provides an electrostatic image developing toner to be used for an image forming method which comprises forming an electrostatic latent image on a photoreceptor made of an inorganic or organic material, developing it with a toner, transferring it to a paper sheet, a plastic film or the like, and fixing it to form a visible image, said toner comprising at least a binder resin, a colorant and a charge control agent, wherein the charge control agent comprises at least one zirconium compound of the above-mentioned formula (1) and at least one specific azo metal complex.

In an electrophotographic process, in order to impart a sufficient tribocharge to an electrostatic image developing toner, in a two component development, it is necessary to drive the developing section for a certain period of time at the time of operation of the system to obtain a tribocharge necessary for the developing step. The shorter the period of time until this necessary tribocharge is obtained, the better. In reality, however, it usually takes a few minutes as the time until a first copy, and a satisfactory initial electrification has not necessarily been obtained. Further, also in a mono component development, the system tends to be expensive, and an excessive charge control agent is used in order to secure a sufficient electrification rising property, whereby there is a serious problem such that the charge control agent tends to remain on various parts.

The present inventors have conducted an extensive study to solve such problems and as a result, have found it very effective that the charge control agent comprises a zirconium compound of the above-mentioned formula (1) and a specific azo metal complex.

The above compound (1) is thermally stable and is not susceptible to a thermal change during the electrophotographic process, whereby a constant electrification property can be maintained. Further, with respect to the electrification property, it shows an extremely quick electrification rising property, and its tribocharge has been found to be higher than an azo metal complex which is presently mostly commonly employed. However, when the above compound (1) is used alone, it has been found that the tribocharge tends to increase gradually during tribo-electrification for a long period of time, whereby it has been found that a problem such as a decrease in the image density is likely to result especially when a long term electrification stability is of importance for e.g. a high speed copying machine.

On the other hand, when an azo metal complex which is presently most commonly used, is used alone, it has been impossible to obtain a sufficient rising of electrification, although there is no problem in the long term electrification stability.

In the present invention, by incorporating the above compound (1) excellent in the electrification rising property and a specific azo metal complex excellent in the long term electrification stability, especially when the zirconium compound is incorporated in an amount of at least S wt % of the azo metal complex, it has been made possible to obtain an electrostatic image developing toner having the characteristics of both components.

The specific azo metal complex may, for example, be an azo type chromium complex, an azo type zinc complex or an azo type iron complex. Specifically, azo metal complexes of the following chemical formula may be mentioned, but the specific azo metal complex is not limited to such specific examples.

[chemical structure]

The electrophotographic toner of the present invention i.e. the electrostatic image developing toner suitable for recycling, is composed basically of a binder resin, a colorant (a pigment, a dye or a magnetic material) and a charge control agent comprising a zirconium compound of the above formula (1) As a method for preparing the electrophotographic toner, there may be mentioned, for example, a method wherein such a mixture is kneaded while melting the binder resin by a heat-mixing apparatus and cooled, followed by rough pulverization, fine pulverization and classification, a method wherein such a mixture is dissolved in a solvent, followed by spraying to form fine particles, which are then dried and classified, or a method wherein a colorant and the compound of the formula (1) are dispersed in suspended monomers particles, followed by polymerization.

The electrophotographic toner of the present invention i.e. the electrostatic image developing toner which is excellent in the electrification rising property and which has a long term electrification stability, is composed basically of a binder resin, a colorant (a pigment, a dye or a magnetic material), and a charge control agent comprising the zirconium compound of the formula (1) and an azo metal complex. As a method for preparing such an electrophotographic toner, there may be mentioned, for example, a method wherein such a mixture is kneaded while melting the binder resin by a heat-mixing apparatus and cooled, followed by rough pulverization, fine pulverization and classification, a method wherein such a mixture is dissolved in a solvent, followed by spraying to form fine particles, which are then dried and classified, or a method wherein a colorant and the charge control agent comprising the compound of the formula (1) and an azo metal complex, are dispersed in suspended monomer particles, followed by polymerization.

To present an electrostatic image developing toner having an excellent electrification rising property and electrification stability, which is capable of maintaining a constant electrification control effect and providing a clear image even in repeated printing operation for a long period of time and which is free from a problem from the viewpoint of environmental safety, the present invention provides an electrostatic image developing toner to be used for an image forming method which comprises forming an electrostatic latent image on a photoreceptor made of an inorganic or organic material, developing it with a toner, transferring it to a paper sheet, a plastic film or the like, and fixing it to form a visible image, said toner comprising at least a binder resin, a magnetic material and a charge control agent of the above formula (1) and having a saturation magnetization of from 2 to 50 Am²/kg and a coercive force of from 40 to 200 oersted.

In a one component developer process as an electrophotographic process, it is necessary to use a charge control agent in order to impart a sufficient tribocharge in a very short period of time to an electrostatic image developing toner. It is known that a certain chromium compound is effective for remarkably improving the electrification rising property. However, it has had a problem from the viewpoint of environmental safety, as it is a chromium compound. It is also known that a certain iron compound exhibits a negative electrification control effect, but as compared with a chromium compound, this compound is inadequate in the electrification rising property in a mono component development.

The present inventors have conducted an extensive study to solve such problems and as a result, have found it very effective that the charge control agent is a zirconium compound of the above formula (1).

The compound (1) is thermally stable and is not susceptible to a thermal change during the electrophotographic process, whereby a constant electrification property can be maintained. Further, with respect to the electrification property, it exhibits a very quick electrification rising property, and its tribocharge has been found to be higher than the above-mentioned azo chromium complex or the azo iron complex which are presently most commonly employed.

The present inventors have made a magnetic toner for a mono component development by using the above compound (1) excellent in the electrification rising property. Further, in order to obtain a clear initial image by using this toner, a study has been made by applying various magnetic properties of the magnetic toner, and as a result, it has been found that when the magnetic properties are within a certain range, the image quality of an initial image will be excellent. Namely, it has been found that when the above compound (1) is applied to an electrostatic image developing magnetic toner having a saturation magnetization of from 20 to 50 Am²/kg and a coercive force of from 40 to 200 oersted, the balance of the tribocharge and the magnetic properties will be proper, a sufficient image density can be obtained, and a good image quality can be maintained without background fogging, and the present invention has been accomplished on the basis of this discovery.

Such an electrophotographic toner of the present invention is composed basically of a binder resin, a magnetic material as a colorant and a charge control agent comprising the zirconium compound of the above formula (1). As a method for producing such an electrophotographic toner, there may be mentioned, for example, a method wherein such a mixture is kneaded while melting the binder resin by a heat-mixing apparatus and cooled, followed by rough pulverization, fine pulverization and classification, a method wherein such a mixture is dissolved in a solvent, followed by spraying to obtain fine particles, which are then dried and classified, or a method wherein a colorant and a compound of the formula (1) are dispersed in suspended monomer particles, followed by polymerization.

The binder resin to be used in the present invention preferably has a glass transition point of from 40 to 90° C., a number average molecular·weight (Mn) of from 1,500 to 50,000, a weight average molecular weight (Mw) of from 10,000 to 3,000,000, an acid value of at most 50 and an acid value of at least 50.

The binder resin is, for example, a polymer or a copolymer of a monomer selected from the group consisting of styrene type monomers, acrylic monomers and methacrylic nmonomers, and specifically it may be made of a monomer component selected from the group consisting of styrene, o-methylstyrene, m-methylstyrene, p-methylstyrene, p-methoxystyrene, p-ethylstyrene, acrylic acid, α-ethylacrylic acid, crotonic acid, methyl acrylate, ethyl acrylate, n-butyl acrylate, isobutyl acrylate, n-propyl acrylate, n-octyl acrylate, dodecyl acrylate, 2-ethylhexyl acrylate, stearyl acrylate, 2-chloroethyl acrylate, phenyl acrylate, 2-hydroxyethyl acrylate, methacrylic acid, methyl methacrylate, ethyl methacrylate, n-propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate, diethylaminoethyl methacrylate, 2-hydroxyethyl methacrylate; acrylonitrile, methacrylonitrile and acrylamide.

In the case of a polyester type, the alcohol component may, for example, be a diol such as ethylene glycol, propylene glycol, 1, 3-butanediol, 1,4-butanediol, 2,3-butanediol, diethylene glycol, triethylene glycol, 1,5-pentanediol, 1,6-hexanediol, neopentyl glycol, 2-ethyl-1,3-hexanediol or a bisphenol A derivative such as hydrogenated bisphenol A, or a known polyhydric alcohol such as glycerol, sorbitol, sorbitan or pentaerythritol. The acid component may, for example, be a benzenedicarboxylic acid or its anhydride, such as phthalic acid, terephthalic acid, isophthalic acid or phthalic anhydride; an alkyldicarboxylic acid such as succinic acid, adipic acid, sebacic acid or azelaic acid, or its anhydride; succinic acid having a C₆₋₁₈. alkyl or alkenyl group as a substituent, or its anhydride; a known unsaturated dicarboxylic acid such as fumaric acid, maleic acid, citraconic acid or itaconic acid, or its anhydride, or a tri- or higher hydric carboxylic acid such as trimellitic acid, pyromellitic acid or benzophenonetetracarboxylic acid, or its anhydride. Further, it may be a polyester composed solely of an aromatic compound or an aliphatic compound. These binder resins may be used alone or in combination as a mixture of two or more of them.

As the colorant, for a black colored toner, carbon black is usually employed for a two component development. A certain magnetic material is used for a mono component development, and the following colorants may be employed for a color toner. As a yellow colorant, an azo type organic pigment such as CT pigment yellow-1, CI pigment yellow 5, CI pigment yellow 12 or CI pigment yellow 17, or an inorganic pigment such as Chinese yellow, or an oil-soluble dye such as CI solvent yellow 2, CI solvent yellow 6, CI solvent yellow 14 or CI solvent yellow 19, may, for example, be mentioned. As a magenta colorant, an azo pigment such as CI pigment 57 or CI pigment red 57:1, a xanthene pigment such as CI pigment violet 1 or CI pigment 81, a thioindigo pigment such as Cl pigment red 87, CI vat red 1 or CI pigment violet 38, or an oil-soluble dye such as CI solvent red 19, CI solvent red 49 or CI solvent red 52, may, for example, be mentioned. As a cyan colorant, a triphenylmethane pigment such as CI pigment blue 1, a phthalocyanine pigment such as CI pigment blue 15 or CI pigment blue 17, or an oil-soluble dye such as CI solvent blue 25, CI solvent blue 40 or CI solvent blue 70, may, for example, be used.

The zirconium compound to be used in the present invention may usually be obtained by reacting a metal-imparting agent with a salicylic acid derivative in water and/or an organic solvent, obtaining the product by filtration, followed by washing. The metal-imparting agent to be used for the preparation of this compound, may, for example, be a halogenated zirconium compound such as ZrCl₄, ZrF₄, ZrBr₄ or ZrI₄, an organic acid zirconium compound such as Zr(OR)₄ wherein R is hydrogen, an alkyl group or an alkenyl group, or an inorganic acid zirconium compound such as Zr (SO₄)₂, in the case of a tetravalent cationic compound. In the case of a bivalent cationic compound of an oxo complex, it may, for example, be an inorganic zirconium compound such as ZrOCl₂, ZrO(NO₃)₂, ZrO(ClOd)₂, H₂ZrO(SO₄)₂, ZrO(SO₄)Na₂SO₄ or ZrO(HPO₄)₂, or an organic zirconium compound such as ZrO(CO₃), (NH₄)₂ZrO(COO₃)₂, ZrO(C₂H₃O₂)₂, (NH₄)₂ZrO(C₂H₃O₂)₃ or ZrO(C₁₈H₃₅O₂)₂,

Zirconium compounds represented by the formula (1) to be used in the present invention, thus obtainable, will be shown below.

TABLE 1-1

| Compound No. | 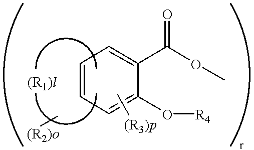 | (Zr) m (O) n (OH) s | r |
|---|---|---|---|
| 1 | 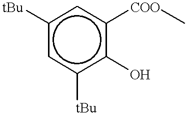 | m: 4, n: 4, s: 3 | 5 |
| 2 | 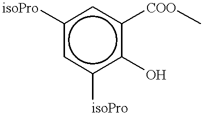 | m: 4, n: 4, s: 3 | 5 |
| 3 | 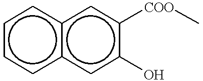 | m: 4, n: 4, s: 3 | 5 |
| 4 | 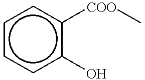 | m: 4, n: 4, s: 3 | 5 |
| 5 | 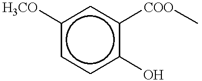 | m: 4, n: 4, s: 3 | 5 |
| 6 | 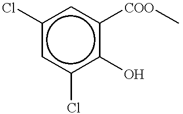 | m: 4, n: 4, s: 3 | 5 |
| 7 | 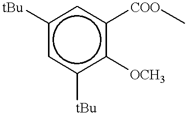 | m: 4, n: 4, s: 3 | 5 |
| 8 | 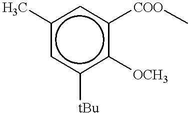 | m: 4, n: 4, s: 3 | 5 |
| 9 | 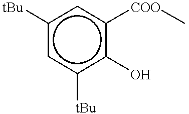 | m: 4, n: 4, s: 2 | 6 |
| 10 | 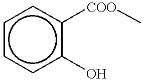 | m: 4, n: 4, s: 2 | 6 |
| 11 | 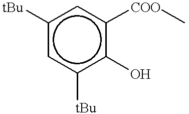 | m: 4, n: 4, s: 4 | 4 |
| 12 | 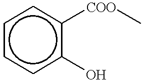 | m: 4, n: 4, s: 4 | 4 |
| 13 | 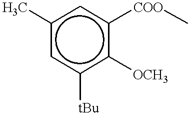 | m: 1, n: 0, s: 0 | 4 |
| 14 | 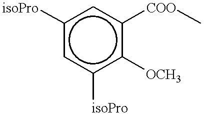 | m: 1, n: 0, s: 0 | 4 |
| 15 | 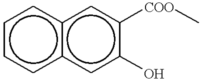 | m: 1, n: 0, s: 0 | 4 |
| 16 | 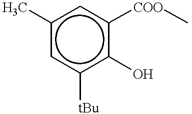 | m: 1, n: 0, s: 0 | 4 |
| 17 | 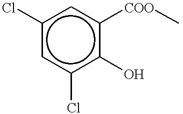 | m: 1, n: 0, s: 0 | 4 |
| 18 | 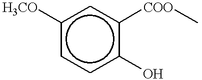 | m: 1, n: 0, s: 0 | 4 |
| 19 | 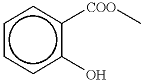 | m: 1, n: 0, s: 0 | 4 |
| 20 | 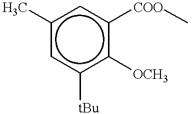 | m: 1, n: 0, s: 0 | 4 |

For the purpose of protecting the photoreceptor or carrier, improving the cleaning property, improving the flowability of the toner, adjusting the thermal property, the electrical property or the physical property, adjusting the resistance, adjusting the softening point or improving the fixing property, the electrgphotographic toner of the Present invention may contain other additives including, for example, hydrophobic silica, a metal soap, a fluorine type surfactant, dioctyl phthalate, wax, a conductivity-imparting agent such as tin oxide, zinc oxide, carbon black or antimony oxide, or an inorganic fine powder such as titanium oxide, aluminum oxide or alumina, as the case requires. The inorganic fine powder to be used in the present invention may preferably be treated with a treating agent or a combination of various treating agents, such as silicone varnish, various modified silicone varnishes, silicone oil, various modified silicone oils, a silane coupling agent, a silane coupling agent having a functional group and other organic silicone compounds, for the purpose of imparting hydrophobicity or controlling the tribocharge. Further, a lubricant such as Teflon, zinc stearate or polyvinylidene fluoride, an abrasive such as cesium oxide, silicon carbide or strontium titanate and a caking-preventive agent may be incorporated. Furthermore, white fine particles and black fine particles having a polarity opposite to toner particles may also be used in a small amount as a developability-improving agent.

When the toner of the present invention is employed in a two-component developer, it is possible to use, as the carrier, a binder type carrier of resin particles having fine glass beads, iron powder, ferrite powder, nickel powder or magnetic particles dispersed therein, or a resin-coated carrier having the surface coated with e.g. a polyester resin, a fluorine resin, a vinyl resin, an acrylic resin or a silicone resin. Further, a toner containing the compound of the formula (1) according to the present invention exhibits excellent performance also when used as a single component toner. Furthermore, it can be used for a capsule toner and a polymerized toner.

The magnetic material may, for example, be a metal fine powder of e.g. iron, nickel or cobalt, an alloy of a metal such as iron, lead, magnesium, antimony, beryllium, bismuth, cadmium, calcium, manganese, selenium, titanium, tungsten, vanadium, cobalt, copper, aluminum, nickel or zinc, a metal oxide such as aluminum oxide, iron oxide or titanium oxide, a ferrite of e.g. iron, manganese, nickel, cobalt or zinc, a nitride such as vanadium nitride or chromium nitride, a carbide such as tungsten carbide or silicon carbide, or a mixture thereof. As the magnetic material, an iron oxide such as magnetite, hematite or ferrite is preferred. However, the charge control agent of the present invention presents excellent electrification performance irrespective of the type of the magnetic material.

Now, the present invention will be described in further detail with reference to various Examples. However, it should be understood that the present invention is by no means restricted to such specific Examples. Further, in the following description, “parts” means “parts by weight”.

Toner for Recycling

### EXAMPLE 1

| | |
|---|---|
| Styrene-acrylic copolymer resin | 91 parts |
| (CPR-100, tradename, manufactured by | |
| Mitsui Chemical Co., Ltd.) | |
| Zirconium compound (Compound No. 1) | 1 part |
| Carbon black (MA-100, tradename, | 5 parts |
| manufactured by Mitsubishi Chemical | |
| Corporation) | |
| Low molecular weight polypropylene | 3 parts |
| (Biscoal 550P, tradename, manufactured | |
| by Sanyo Kasei K.K.) | |

The above mixture was melted and kneaded by a heat-mixing apparatus at 140° C., and the mixture was cooled and roughly pulverized by a hammer mill. It was further finely pulverized by a jet mill and then classified to obtain a black toner having a particle size of from 10 to 12 μm. This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus, and the electrification distribution was measured by an E-SPART analyzer. Further, an image test by a modified commercial copying machine was also carried out. Firstly, a running test up to 50,000 sheets was carried out in a system where no recycling of the toner was carried out. Further, using a toner obtained by mixing the toner recovered from the above test in an amount of 20 wt % to a fresh toner, the blow off charge measurement and the electrification distribution measurement were carried out under the same conditions as the above methods. Further, using this toner, an image test up to 50,000 sheets was carried out. The results are shown in Table 2. In both tests i.e. one with the fresh toner and the other with the toner obtained by mixing the recovered toner in an amount of 20 wt % to the fresh toner, a sufficient image density was obtained, no fogging or scattering in the machine was observed, and a high quality image was obtained over a long period of time.

### EXAMPLE 2

| | |
|---|---|
| Styrene-acrylic copolymer resin | 91 parts |
| (CPR-100, tradename, manufactured by | |
| Mitsui Chemical Co., Ltd.) | |
| Zirconium compound (Compound No. 2) | 1 part |
| Carbon black (MA-100, tradename, | 5 parts |
| manufactured by Mitsubishi Chemical | |
| Corporation) | |
| Low molecular weight polypropylene | 3 parts |
| (Biscoal 550P, tradename, manufactured | |
| by Sanyo Kasei K.K.) | |

The above mixture was melted and kneaded by a heat-mixing apparatus at 140° C., and the mixture was cooled and roughly pulverized by a hammer mill. It was further finely pulverized by a jet mill and then classified to obtain a black toner having a particle size of from 10 to 12 μm.

This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus, and the electrification distribution was measured by an E-SPART analyzer. Further, an image test by a modified commercial copying machine was also carried out. Firstly, a running test up to 50,000 sheets was carried out in a system where is no recycling of the toner was carried out. Further, using a toner obtained by mixing the toner recovered from the above test in an amount of 20 wt % to a fresh toner, the blow off charge measurement and the electrification distribution measurement were carried out under the same conditions as the above methods. Further, using this toner, an image test up to 50,000 sheets was carried out, The results are shown in Table 2. In both tests i.e. one with the fresh toner and the other with the toner obtained by mixing the recovered toner in an amount of 20 wt % to the fresh toner, a sufficient image density was obtained, no fogging or scattering in the machine was observed, and a high quality image was obtained over a long period of time.

### EXAMPLE 3

| | |
|---|---|
| Styrene-acrylic copolymer resin | 91 parts |
| (CPR-100, tradename, manufactured by | |
| Mitsui Chemical Co., Ltd.) | |
| Zirconium compound (Compound No. 10) | 1 part |
| Carbon black (MA-100, tradename, | 5 parts |
| manufactured by Mitsubishi Chemical | |
| Corporation) | |
| Low molecular weight polypropylene | 3 parts |
| (Biscoal 550P, tradename, manufactured | |
| by Sanyo Kasei K.K.) | |

The above mixture was melted and kneaded by a heat-mixing apparatus at 140° C., and the mixture was cooled and roughly pulverized by a hammer mill. It was further finely pulverized by a jet mill and then classified to obtain a black toner having a particle size of from 10 to 12 μm. This toner was mixed with a silicon coated ferrite carrier (F96-100, tradename, manufactured by Powder Tech Co,) in a weight ratio of 4:100, and the mixture was shaked to negatively electrify the toner. Then, the charge was measured by a blow off charge measuring apparatus, and the electrification distribution was measured by an E-SPART analyzer. Further, an image test by a modified commercial copying machine was also carried out. Firstly, a running test up to 50,000 sheets was carried out in a system where no recycling of the toner was carried out. Further, using a toner obtained by mixing the toner recovered from the above test in an amount of 20 wt % to a fresh toner, the blow off charge measurement and the electrification distribution measurement were carried out under the same conditions as the above methods. Further, using this toner, an image test up to 50,000 sheets was carried out. The results are shown in Table 2. In both tests i.e. one with the fresh toner and the other with the toner obtained by mixing the recovered toner in an amount of 20 wt % to the fresh toner, a sufficient image density was obtained, no fogging or scattering in the machine was observed, and a high quality image was obtained over a long period of time.

### EXAMPLE 4

| | |
|---|---|
| Polyester resin (HP-301, | 91 parts |
| tradename, manufactured by | |
| Nippon Gosei Kagaku K.K.) | |
| Zirconium compound (Compound No. 1) | 1 part |
| Carbon black (MA-100, tradename, | 5 parts |
| manufactured by Mitsubishi Chemical | |
| Corporation) | |
| Low molecular weight polypropylene | 3 parts |
| (Biscoal 550P, tradename, manufactured | |
| by Sanyo Kasei K.K.) | |

The above mixture was melted and kneaded by a heat-mixing apparatus at 160° C., and the mixture was cooled and roughly pulverized by a hammer mill. It was further finely pulverized by a jet mill and then classified to obtain a black toner having a particle size of from 10 to 12 μm. This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus, and the electrification distribution was measured by an E-SPART analyzer. Further, an image test by a modified commercial copying machine was also carried out. Firstly, a running test up to 50,000 sheets was carried out in a system where no recycling of the toner was carried out. Further, using a toner obtained by mixing the toner recovered from the above test in an amount of 20 wt % to a fresh toner, the blow off charge measurement and the electrification distribution measurement were carried out under the same conditions as the above methods. Further, using this toner, an image test up to 50,000 sheets was carried out. The results are shown in Table 2. In both tests i.e. one with the fresh toner and the other with the toner obtained by mixing the recovered toner in an amount of 20 wt % to the fresh toner, a sufficient image density was obtained, no fogging or scattering in the machine was observed, and a high quality image was obtained over a long period of time.

### EXAMPLE 5

| | |
|---|---|
| Polyester resin (HP-301, | 91 parts |
| tradename, manufactured by | |
| Nippon Gosei Kagaku K.K.) | |
| Zirconium compound (Compound No. 2) | 1 part |
| Carbon black (MA-100, tradename, | 5 parts |
| manufactured by Mitsubishi Chemical | |
| Corporation) | |
| Low molecular weight polypropylene | 3 parts |
| (Biscoal 550P, tradename, manufactured | |
| by Sanyo Kasei K.K.) | |

The above mixture was melted and kneaded by a heat-mixing apparatus at 160° C., and the mixture was cooled and roughly pulverized by a hammer mill. It was further finely pulverized by a jet mill and then classified to obtain a black toner having a particle size of from 10 to 12 μm. This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus, and the electrification distribution was measured by an E-SPART analyzer. Further, an image test by a modified commercial copying machine was also carried out. Firstly, a running test up to 50,000 sheets was carried out in a system where no recycling of the toner was carried out. Further, using a toner obtained by mixing the toner recovered from the above test in an amount of 20 wt % to a fresh toner, the blow off charge measurement and the electrification distribution measurement were carried out under the same conditions as the above methods. Further, using this toner, an image test up to 50,000 sheets was carried out. The results are shown in Table 2. In both tests i.e. one with the fresh toner and the other with the toner obtained by mixing the recovered toner in an amount of 20 wt % to the fresh toner, a sufficient image density was obtained, no fogging or scattering in the machine was observed, and a high quality image was obtained over a long period of time.

### EXAMPLE 6

| | |
|---|---|
| Polyester resin (HP-301, | 91 parts |
| tradename, manufactured by | |
| Nippon Gosei Kagaku K.K.) | |
| Zirconium compound (Compound No. 10) | 1 part |
| Carbon black (MA-100, tradename, | 5 parts |
| manufactured by Mitsubishi Chemical | |
| Corporation) | |
| Low molecular weight polypropylene | 3 parts |
| (Biscoal 550P, tradename, manufactured | |
| by Sanyo Kasei K.K.) | |

The above mixture was melted and kneaded by a heat-mixing apparatus at 160° C., and the mixture was cooled and roughly pulverized by a hammer mill. It was further finely pulverized by a jet mill and then classified to obtain a black toner having a particle size of from 10 to 12 μm. This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus, and the electrification distribution was measured by an E-SPART analyzer. Further, an image test by a modified commercial copying machine was also carried out. Firstly, a running test up to 50,000 sheets was carried out in a system where no recycling of the toner was carried out. Further, using a toner obtained by mixing the toner recovered from the above test in an amount of 20 wt % to a fresh toner, the blow off charge measurement and the electrification distribution measurement were carried out under the same conditions as the above methods. Further, using this toner, an image test up to 50,000 sheets was carried out. The results are shown in Table 2. In both tests i.e. one with the fresh toner and the other with the toner obtained by mixing the recovered toner in an amount of 20 wt % to the fresh toner, a sufficient image density was obtained, no fogging or scattering in the machine was observed, and a high quality image was obtained over a long period of time.

### EXAMPLE 7

| | |
|---|---|
| Styrene-acrylic copolymer resin | 91 parts |
| (FB-1258, tradename, manufactured by | |
| Mitsui Rayon Co., Ltd.) | |
| Zirconium compound (Compound No. 1) | 1 part |
| Carbon black (MA-100, tradename, | 5 parts |
| manufactured by Mitsubishi Chemical | |
| Corporation) | |
| Low molecular weight polypropylene | 3 parts |
| (Biscoal 550P, tradename, manufactured | |
| by Sanyo Kasei K.K.) | |

The above mixture was melted and kneaded by a heat-mixing apparatus at 140° C., and the mixture was cooled and roughly pulverized by a hammer mill. It was further finely pulverized by a jet mill and then classified to obtain a black toner having a particle size of from 10 to 12 μm.

This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus, and the electrification distribution was measured by an E-SPART analyzer. Further, an image test by a modified commercial copying machine was also carried out. Firstly, a running test up to 50,000 sheets was carried out in a system where no recycling of the toner was carried out. Further, using a toner obtained by mixing the toner recovered from the above test in an amount of 20 wt % to a fresh toner, the blow off charge measurement and the electrification distribution measurement were carried out under the same conditions as the above methods. Further, using this toner, an image test up to 50,000 sheets was carried out. The results are shown in Table 2. In both tests i.e. one with the fresh toner and the other with the toner obtained by mixing the recovered toner in an amount of 20 wt % to the fresh toner, a sufficient image density was obtained, no fogging or scattering in the machine was observed, and a high quality image was obtained over a long period of time.

### EXAMPLE 8

| | |
|---|---|
| Styrene-acrylic copolymer resin | 91 parts |
| (FB-1258, tradename, manufactured by | |
| Mitsui Rayon Co., Ltd.) | |
| Zirconium compound (Compound No. 2) | 1 part |
| Carbon black (MA-100, tradename, | 5 parts |
| manufactured by Mitsubishi Chemical | |
| Corporation) | |
| Low molecular weight polypropylene | 3 parts |
| (Biscoal 550P, tradename, manufactured | |
| by Sanyo Kasei K.K.) | |

The above mixture was melted and kneaded by a heat-mixing apparatus at 140° C., and the mixture was cooled and roughly pulverized by a hammer mill. It was further finely pulverized by a jet mill and then classified to obtain a black toner having a particle size of from 10 to 12 μm. This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus, and the electrification distribution was measured by an E-SPART analyzer. Further, an image test by a modified commercial copying machine was also carried out. Firstly, a running test up to 50,000 sheets was carried out in a system where no recycling of the toner was carried out. Further, using a toner obtained by mixing the toner recovered from the above test in an amount of 20 wt % to a fresh toner, the blow off charge measurement and the electrification distribution measurement were carried out under the same conditions as the above methods. Further, using this toner, an image test up to 50,000 sheets was carried out. The results are shown in Table 2. In both tests i.e. one with the fresh toner and the other with the toner obtained by mixing the recovered toner in an amount of 20 wt % to the fresh toner, a sufficient image density was obtained, no fogging or scattering in the machine was observed, and a high quality image was obtained over a long period of time.

### EXAMPLE 9

| | |
|---|---|
| Styrene-acrylic copolymer resin | 91 parts |
| (FB-1258, tradename, manufactured by | |
| Mitsui Rayon Co., Ltd.) | |
| Zirconium compound (Compound No. 10) | 1 part |
| Carbon black (MA-100, tradename, | 5 parts |
| manufactured by Mitsubishi Chemical | |
| Corporation) | |
| Low molecular weight polypropylene | 3 parts |
| (Biscoal 550P, tradename, manufactured | |
| by Sanyo Kasei K.K.) | |

The above mixture was melted and kneaded by a heat-mixing apparatus at 140° C., and the mixture was cooled and roughly pulverized by a hammer mill. It was further finely pulverized by a jet mill and then classified to obtain a black toner having a particle size of from 10 to 12 μm. This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus, and the electrification distribution was measured by an E-SPART analyzer. Further, an image test by a modified commercial copying machine was also carried out. Firstly, a running test up to 50,000 sheets was carried out in a system where no recycling of the toner was carried out. Further, using a toner obtained by mixing the toner recovered from the above test in an amount of 20 wt % to a fresh toner, the blow off charge measurement and the electrification distribution measurement were carried out under the same conditions as the above methods. Further, using this toner, an image test up to 50,000 sheets was carried out. The results are shown in Table 2. In both tests i.e. one with the fresh toner and the other with the toner obtained by mixing the recovered toner in an amount of 20 wt % to the fresh toner, a sufficient image density was obtained, no fogging or scattering in the machine was observed, and a high quality image was obtained over a long period of time.

### COMPARATIVE EXAMPLE 1

| | |
|---|---|
| Styrene-acrylic copolymer resin | 91 parts |
| (CPR-100, tradename, manufactured by | |
| Mitsui Rayon Co., Ltd.) | |
| Charge control agent (T-77, tradename | 1 part |
| manufactured by Hodogaya Chemical | |
| Co., Ltd.) | |
| Carbon black (MA-100, tradename, | 5 parts |
| manufactured by Mitsubishi Chemical | |
| Corporation) | |
| Low molecular weight polypropylene | 3 parts |
| (Biscoal 550P, tradename, manufactured | |
| by Sanyo Kasei K.K.) | |

The above mixture was melted and kneaded by a heat-mixing apparatus at 140° C., and the mixture was cooled and roughly pulverized by a hammer mill. It was further finely pulverized by a jet mill and then classified to obtain a black toner having a particle size of from 10 to 12 μm. This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus, and the electrification distribution was measured by an E-SPART analyzer. Further, an image test by a modified commercial copying machine was also carried out. Firstly, a running test up to 50,000 sheets was carried out in a system where no recycling of the toner was carried out. Further, using a toner obtained by mixing the toner recovered from the above test in an amount of 20 wt % to a fresh toner, the blow off charge measurement and the electrification distribution measurement were carried out under the same conditions as the above methods, Further, using this toner, an image test up to 50,000 sheets was carried out, The results are shown in Table 2. In the image test with the fresh toner, a sufficient image density was obtained, no fogging or scattering in the machine was observed, and a high quality image was obtained over a long period of time, but in the test with the toner obtained by mixing the recovered toner in an amount of 20 wt % to the fresh toner, a decrease in the image density was observed, fogging tended to increase and it was not possible to obtain a satisfactory image.

### COMPARATIVE EXAMPLE 2

| | | |
|---|---|---|
| Styrene-acrylic copolymer resin | 91 | parts |
| (CPR-100, tradename, manufactured by | | |
| Mitsui Chemical Co., Ltd.) | | |
| Charge control agent (Spilonblack TRH, | 1 | part |
| tradename manufactured by Hodogaya | | |
| Chemical Co., Ltd.) | | |
| Carbon black (MA-100, tradename, | 5 | parts |
| manufactured by Mitsubishi Chemical | | |
| Corporation) | | |
| Low molecular weight polypropylene | 3 | parts |
| (Biscoal 550P, tradename, manufactured | | |
| by Sanyo Kasei K.K.) | | |

The above mixture was melted and kneaded by a heat-mixing apparatus at 140° C., and the mixture was cooled and roughly pulverized by a hammer mill. It was further finely pulverized by a jet mill and then classified to obtain a black toner having a particle size of from 10 to 12 μm. This toner was mixed with a silicon coated ferrite carrier (F96-100, tradename, manufactured by Powder Tech Co.) in a weight ratio of 4.100, and the mixture was shaked to negatively electrify the toner. Then, the charge was measured by a blow off charge measuring apparatus, and the electrification distribution was measured by an E-SPART analyzer. Further, an image test by a modified commercial copying machine was also carried out. Firstly, a running test up to 50,000 sheets was carried out in a system where no recycling of the toner was carried out. Further, using a toner obtained by mixing the toner recovered from the above test in an amount of 20 wt % to a fresh toner, the blow off charge measurement and the electrification distribution measurement were carried out under the same conditions as the above methods. Further, using this toner, an image test up to 50,000 sheets was carried out. The results are shown in Table 2. In the image test with the fresh toner, a sufficient image density was obtained, no fogging or scattering in the machine was observed, and a high quality image was obtained over a long period of time, but in the test with the toner obtained by mixing the recovered toner in an amount of 20 wt % to the fresh toner, a decrease in the image density was observed, fogging tended to increase and it was not possible to obtain a satisfactory image.

### COMPARATIVE EXAMPLE 3

| | | |
|---|---|---|
| Styrene-acrylic copolymer resin | 91 | parts |
| (CPR-100, tradename, manufactured by | | |
| Mitsui Chemical Co., Ltd.) | | |
| Charge control agent (Borotoron E-84, | 1 | part |
| Tradename, manufactured by Orient | | |
| Chemical Co., Ltd.) | | |
| Carbon black (MA-100, tradename, | 5 | parts |
| manufactured by Mitsubishi Chemical | | |
| Corporation) | | |
| Low molecular weight polypropylene | 3 | parts |
| (Biscoal 550P, tradename, manufactured | | |
| by Sanyo Kasei K.K.) | | |

The above mixture was melted and kneaded by a heat-mixing apparatus at 140° C., and the mixture was cooled and roughly pulverized by a hammer mill. It was further finely pulverized by a jet mill and then classified to obtain a black toner having a particle size of from 10 to 12 μm. This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus, and the electrification distribution was measured by an E-SPART analyzer. Further, an image test by a modified commercial copying machine was also carried out. Firstly, a running test up to 50,000 sheets was carried out in a system where no recycling of the toner was carried out. Further, using a toner obtained by mixing the toner recovered from the above test in an amount of 20 wt % to a fresh toner, the blow off charge measurement and the electrification distribution measurement were carried out under the same conditions as the above methods. Further, using this toner, an image test up to 50,000 sheets was carried out. The results are shown in Table 2. In the image test with the fresh toner, a sufficient image density was obtained, no fogging or scattering in the machine was observed, and a high quality image was obtained over a long period of time, but in the test with the toner obtained by mixing the recovered toner in an amount of 20 wt % to the fresh toner, a decrease in the image density was observed, fogging tended to increase and it was not possible to obtain a satisfactory image.

### COMPARATIVE EXAMPLE 4

| | | |
|---|---|---|
| Polyester resin (HP-301, tradename, | 91 | parts |
| manufactured by Nippon Gosei Kagaku K.K.) | | |
| Charge control agent (T-77, tradename, | 1 | part |
| manufactured by Hodogaya Chemical Co., Ltd. | | |
| Carbon black (MA-100, tradename, | 5 | parts |
| manufactured by Mitsubishi Chemical Corporation) | | |
| Low molecular weight polypropylene | 3 | parts |
| (Biscoal 550P, tradename, manufactured | | |
| by Sanyo Kasei K.K.) | | |

The above mixture was melted and kneaded by a heat-mixing apparatus at 160° C., and the mixture was cooled and roughly pulverized by a hammer mill. It was further finely pulverized by a jet mill and then classified to obtain a black toner having a particle size of from 10 to 12 μm.

This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus, and the electrification distribution was measured by an E-SPART analyzer. Further, an image test by a modified commercial copying machine was also carried out. Firstly, a running test up to 50,000 sheets was carried out in a system where no recycling of the toner was carried out. Further, using a toner obtained by mixing the toner recovered from the above test in an amount of 20 wt % to a fresh toner, the blow off charge measurement and the electrification distribution measurement were carried out under the same conditions as the above methods. Further, using this toner, an image test up to 50,000 sheets was carried out. The results are shown in Table 2. In the image test with the fresh toner, a sufficient image density was obtained, no fogging or scattering in the machine was observed, and a high quality image was obtained over a long period of time, but in the test with the toner obtained by mixing the recovered toner in an amount of 20 wt % to the fresh toner, a decrease in the image density was observed, fogging tended to increase and it was not possible to obtain a satisfactory image.

### COMPARATIVE EXAMPLE 5

| | | |
|---|---|---|
| Polyester resin (HP-301, tradename, | 91 | parts |
| manufactured by Nippon Gosei Kagaku K.K.) | | |
| Charge control agent (Spilonblack TRH, | 1 | part |
| Tradename, manufactured by Hodogaya | | |
| Chemical Co., Ltd. | | |
| Carbon black (MA-100, tradename, | 5 | parts |
| manufactured by Mitsubishi Chemical Corporation) | | |
| Low molecular weight polypropylene | 3 | parts |
| (Biscoal 550P, tradename, manufactured | | |
| by Sanyo Kasei K.K.) | | |

The above mixture was melted and kneaded by a heat-mixing apparatus at 160° C., and the mixture was cooled and roughly pulverized by a hammer mill. It was further finely pulverized by a jet mill and then classified to obtain a black toner having a particle size of from 10 to 12 μm. This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus, and the electrification distribution was measured by an E-SPART analyzer. Further, an image test by a modified commercial copying machine was also carried out. Firstly, a running test up to 50,000 sheets was carried out in a system where no recycling of the toner was carried out. Further, using a toner obtained by mixing the toner recovered from the above test in an amount of 20 wt % to a fresh toner, the blow off charge measurement and the electrification distribution measurement were carried out under the same conditions as the above methods. Further, using this toner, an image test up to 50,000 sheets was carried out. The results are shown in Table 2. In the image test with the fresh toner, a sufficient image density was obtained, no fogging or scattering in the machine was observed, and a high quality image was obtained over a long period of time, but in the test with the toner obtained by mixing the recovered toner in an amount of 20 wt % to the fresh toner, a decrease in the image density was observed, fogging tended to increase and it was not possible to obtain a satisfactory image.

### COMPARATIVE EXAMPLE 6

| | | |
|---|---|---|
| Polyester resin (HP-301, tradename, | 91 | parts |
| manufactured by Nippon Gosei Kagaku K.K.) | | |
| Charge control agent (Borotoron E-84, | 1 | part |
| tradename, manufactured by Orient | | |
| Chemical Co., Ltd. | | |
| Carbon black (MA-100, tradename, | 5 | parts |
| manufactured by Mitsubishi Chemical Corporation) | | |
| Low molecular weight polypropylene | 3 | parts |
| (Biscoal 550P, tradename, manufactured | | |
| by Sanyo Kasei K.K.) | | |

The above mixture was melted and kneaded by a heat-mixing apparatus at 160° C., and the mixture was cooled and roughly pulverized by a hammer mill. It was further finely pulverized by a jet mill and then classified to obtain a black toner having a particle size of from 10 to 12 μm. This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus, and the electrification distribution was measured by an E-SPART analyzer. Further, an image test by a modified commercial copying machine was also carried out. Firstly, a running test up to 50,000 sheets was carried out in a system where no recycling of the toner was carried out. Further, using a toner obtained by mixing the toner recovered from the above test in an amount of 20 wt % to a fresh toner, the blow off charge measurement and the electrification distribution measurement were carried out under the same conditions as the above methods. Further, using this toner, an image test up to 50,000 sheets was carried out. The results are shown in Table 2. In the image test with the fresh toner, a sufficient image density was obtained, no fogging or scattering in the machine was observed, and a high quality image was obtained over a long period of time, but in the test with the toner obtained by mixing the recovered toner in an amount of 20 wt % to the fresh toner, a decrease in the image density was observed, fogging tended to increase and it was not possible to obtain a satisfactory image.

TABLE 2

| | | | Evaluation of toner | | | | |
|---|---|---|---|---|---|---|---|
| | | | | | In recycling | | |
| | | | Charge 1 | Charge 2 | Image | | Scattering |
| | | | (μC/g) | (μC/g) | density | Fogging | of toner |
| | | Charge | Initial | Initial | Initial | Initial | Initial |
| | Resin | control | 50,000 | 50,000 | 50,000 | 50,000 | 50,000 |
| Example No. | (tradename) | agent | sheets | sheets | sheets | sheets | sheets |
| 1 | SA | Compound | −23.5 | −23.2 | ∘ | ∘ | ∘ |
| | (CPR-100) | No. 1 | −23.0 | −23.5 | ∘ | ∘ | ∘ |
| 2 | SA | Compound | −22.6 | −22.8 | ∘ | ∘ | ∘ |
| | (CPR-100) | No. 2 | −22.2 | −22.2 | ∘ | ∘ | ∘ |
| 3 | SA | Compound | −23.5 | −23.1 | ∘ | ∘ | ∘ |
| | (CPR-100) | No. 10 | −22.9 | −22.2 | ∘ | ∘ | ∘ |
| 4 | PE | Compound | −25.2 | −23.9 | ∘ | ∘ | ∘ |
| | (HP-301) | No. 1 | −23.5 | −24.9 | ∘ | ∘ | ∘ |
| 5 | PE | Compound | −24.7 | −24.2 | ∘ | ∘ | ∘ |
| | (HP-301) | No. 2 | −24.1 | −22.7 | ∘ | ∘ | ∘ |
| 6 | PE | Compound | −24.0 | −23.2 | ∘ | ∘ | ∘ |
| | (HP-301) | No. 10 | −24.2 | −23.8 | ∘ | ∘ | ∘ |
| 7 | SA | Compound | −22.8 | −23.8 | ∘ | ∘ | ∘ |
| | (FB-1258) | No. 1 | −22.0 | −22.8 | ∘ | ∘ | ∘ |
| 8 | SA | Compound | −22.4 | −21.2 | ∘ | ∘ | ∘ |
| | (FB-1258) | No. 2 | −22.2 | −22.9 | ∘ | ∘ | ∘ |
| 9 | SA | Compound | −22.0 | −21.2 | ∘ | ∘ | ∘ |
| | (FB-1258) | No. 10 | −21.9 | −22.3 | ∘ | ∘ | ∘ |
| Comparative | SA | T-77 | −12.3 | −10.5 | Δ | Δ | ∘ |
| Example 1 | (CPR-100) | | −8.3 | −5.3 | Δ | Δ | ∘ |
| Comparative | SA | TRH | −13.3 | −11.4 | Δ | X | Δ |
| Example 2 | (CPR-100) | | −9.3 | −4.3 | Δ | X | Δ |
| Comparative | SA | E-84 | −22.3 | −15.5 | X | X | X |
| Example 3 | (CPR-100) | | −10.3 | −4.8 | X | X | X |
| Comparative | PE | T-77 | −15.3 | −11.2 | ∘ | ∘ | ∘ |
| Example 4 | (HP-301) | | −10.3 | −7.8 | Δ | Δ | Δ |
| Comparative | PE | TRH | −14.3 | −14.1 | Δ | Δ | Δ |
| Example 5 | (HP-301) | | −13.3 | −8.7 | Δ | X | Δ |
| Comparative | PE | E-84 | −21.3 | −19.3 | X | X | Δ |
| Example 6 | (HP-301) | | −17.3 | −10.5 | X | X | Δ |

Charge 1 represents the blow off charge of the fresh toner, and charge 2 represents the blow off charge of the toner obtained by mixing the waste toner in an amount of 20 wt % to the fresh toner.

In the evaluation of image density, symbol ∘ represents “sufficient image density”, symbol Δ represents “fair image density” and symbol × represents “insufficient image density”. In the evaluation of fogging, symbol ∘ represents “no fogging”, symbol Δ represents “slight fogging”, and symbol × represents “substantial fogging”. In the evaluation of scattering of toner, symbol ∘ represents “no scattering”, symbol A represents “slight scattering”, and symbol × represents “substantial scattering”.

Combined Toner with an Azo Metal Complex

### EXAMPLE 11

| | | |
|---|---|---|
| Styrene-acrylic copolymer resin | 91 | parts |
| (acid value: 0.1) (CPR-100, tradename, | | |
| manufactured by Mitsui Chemical Co., Ltd.) | | |
| Charge control agent | 1 | part |
| Zirconium compound (Compound No. 1) | (0.05 | part) |
| T-77 (tradename, manufactured by | (0.95 | part) |
| Hodogaya Chemical Co., Ltd.) | | |
| Carbon black (MA-100, tradename, | 5 | parts |
| manufactured by Mitsubishi Chemical Corporation) | | |
| Low molecular weight polypropylene | 3 | parts |
| Biscoal 550P, tradename, manufactured | | |
| by Sanyo Kasei K.K.) | | |

The above mixture was melted and kneaded by a heat-mixing apparatus at 140° C., and the mixture was cooled and roughly pulverized by a hammer mill. It was further finely pulverized by a jet mill and then classified to obtain a black toner having a particle size of from 10 to 12 μm.

This toner was mixed with a silicon coated ferrite carrier (F96-100, tradename, manufactured by Powder Tech Co.) in a weight ratio of 4;100, and the mixture was shaked to negatively electrify the toner. Then, the charge was measured by a blow off charge measuring apparatus. Further, the electrification rising property was compared by the time constant. Further, an image test by a modified commercial copying machine was also carried out. The results are shown in Table 3. The electrification rising property was excellent, and a sufficient image density was obtained under all conditions. A high quality image with sufficient reproducibility of a fine line was obtained over a long period of time without fogging.

### EXAMPLE 12

| | | |
|---|---|---|
| Styrene-acrylic copolymer resin | 91 | parts |
| (acid value: 0.1) (CPR-100, tradename, | | |
| manufactured by Mitsui Chemical Co., Ltd.) | | |
| Charge control agent | 1 | part |
| Zirconium compound (Compound No. 1) | (0.10 | part) |
| T-77 (tradename, manufactured by | (0.90 | part) |
| Hodogaya Chemical Co., Ltd.) | | |
| Carbon black (MA-100, tradename, | 5 | parts |
| manufactured by Mitsubishi Chemical Corporation) | | |
| Low molecular weight polypropylene | 3 | parts |
| (Biscoal 550P, tradename, manufactured | | |
| by Sanyo Kasei K.K.) | | |

The above mixture was melted and kneaded by a heat-mixing apparatus at 140° C., and the mixture was cooled and roughly pulverized by a hammer mill. It was further finely pulverized by a jet mill and then classified to obtain a black toner having a particle size of from 10 to 12 μm. This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus. Further, the electrification rising property was compared by the time constant. Further, an image test by a modified commercial copying machine was also carried out. The results are shown in Table 3. The electrification rising property was excellent, and a sufficient image density was obtained under all conditions. A high quality image with sufficient reproducibility of a fine line was obtained over a long period of time without fogging.

### EXAMPLE 13

| | | |
|---|---|---|
| Styrene-acrylic copolymer resin | 91 | parts |
| (acid value: 0.1) (CPR-100, tradename, | | |
| manufactured by Mitsui Chemical Co., Ltd.) | | |
| Charge control agent | 1 | part |
| Zirconium compound (Compound No. 1) | (0.50 | part) |
| T-77 (tradename, manufactured by | (0.50 | part) |
| Hodogaya Chemical Co., Ltd.) | | |
| Carbon black (MA-100, tradename, | 5 | parts |
| manufactured by Mitsubishi Chemical Corporation) | | |
| Low molecular weight polypropylene | 3 | parts |
| (Biscoal 550P, tradename, manufactured | | |
| by Sanyo Kasei K.K.) | | |

The above mixture was melted and kneaded by a heat-mixing apparatus at 140° C., and the mixture was cooled and roughly pulverized by a hammer mill. It was further finely pulverized by a jet mill and then classified to obtain a black toner having a particle size of from 10 to 12 μm. This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus. Further, the electrification rising property was compared by the time constant. Further, an image test by a modified commercial copying machine was also carried out. The results are shown in Table 3. The electrification rising property was excellent, and a sufficient image density was obtained under all conditions. A high quality image with sufficient reproducibility of a fine line was obtained over a long period of time without fogging.

### EXAMPLE 14

| | | |
|---|---|---|
| Styrene-acrylic copolymer resin | 91 | parts |
| (acid value: 0.1) (CPR-100, tradename, | | |
| manufactured by Mitsui Chemical Co., Ltd.) | | |
| Charge control agent | 1 | part |
| Zirconium compound (Compound No. 1) | (0.80 | part) |
| T-77 (tradename, manufactured by | (0.20 | part) |
| Hodogaya Chemical Co., Ltd.) | | |
| Carbon black (MA-100, tradename, | 5 | parts |
| manufactured by Mitsubishi Chemical Corporation) | | |
| Low molecular weight polypropylene | | |
| (Biscoal 550P, tradename, manufactured | 3 | parts |
| by Sanyo Kasei K.K.) | | |

The above mixture was melted and kneaded by a heat-mixing apparatus at 140° C., and the mixture was cooled and roughly pulverized by a hammer mill. It was further finely pulverized by a jet mill and then classified to obtain a black toner having a particle size of from 10 to 12 μm. This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus. Further, the electrification rising property was compared by the time constant, Further, an image test by a modified commercial copying machine was also carried out. The results are shown in Table 3. The electrification rising property was excellent, and a sufficient image density was obtained under all conditions. A high quality image with sufficient reproducibility of a fine line was obtained over a long period of time without fogging.

### EXAMPLE 15

| | | |
|---|---|---|
| Styrene-acrylic copolymer resin | 91 | parts |
| (acid value: 0.1) (CPR-100, tradename, | | |
| manufactured by Mitsui Chemical Co., Ltd.) | | |
| Charge control agent | 1 | part |
| Zirconium compound (Compound No. 1) | (0.05 | part) |
| Spilonblack TRH (tradename, manufactured | (0.95 | part) |
| by Hodogaya Chemical Co., Ltd.) | | |
| Carbon black (MA-100, tradename, | 5 | parts |
| manufactured by Mitsubishi Chemical Corporation) | | |
| Low molecular weight polypropylene | | |
| (Biscoal 550P, tradename, manufactured | 3 | parts |
| by Sanyo Kasei K.K.) | | |

The above mixture was melted and kneaded by a heat-mixing apparatus at 140° C., and the mixture was cooled and roughly pulverized by a hammer mill. It was further finely pulverized by a jet mill and then classified to obtain a black toner having a particle size of from 10 to 12 μm. This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus. Further, the electrification rising property was compared by the time constant. Further, an image test by a modified commercial copying machine was also carried out. The results are shown in Table 3. The electrification rising property was excellent, and a sufficient image density was obtained under all conditions. A high quality image with sufficient reproducibility of a fine line was obtained over a long period of time without fogging.

### EXAMPLE 16

| | | |
|---|---|---|
| Styrene-acrylic copolymer resin (acid value: | 91 | parts |
| 0.1) (CPR-100, tradename, manufactured | | |
| by Mitsui Chemical Co., Ltd.) | | |
| Charge control agent | 1 | part |
| Zirconium compound (Compound No. 1) | (0.10 | part) |
| Spilonblack TRH (tradename, manufactured | (0.90 | part) |
| by Hodogaya Chemical Co., Ltd.) | | |
| Carbon black (MA-100, tradename, | 5 | parts |
| manufactured by Mitsubishi Chemical | | |
| Corporation) | | |
| Low molecular weight polypropylene | 3 | parts |
| (Biscoal 550P, tradename, manufactured | | |
| by Sanyo Kasei K.K.) | | |

The above mixture was melted and kneaded by a heat-mixing apparatus at 140° C., and the mixture was cooled and roughly pulverized by a hammer mill. It was further finely pulverized by a jet mill and then classified to obtain a black toner having a particle size of from 10 to 12 μm. This toner was mixed with a silicon coated ferrite carrier (F96-100, tradename, manufactured by Powder Tech Co.) in a weight ratio of 4;100, and the mixture was shaked to negatively electrify the toner. Then, the charge was measured by a blow off charge measuring apparatus. Further, the electrification rising property was compared by the time constant. Further, an image test by a modified commercial copying machine was also carried out. The results are shown in Table 3. The electrification rising property was excellent, and a sufficient image density was obtained under all conditions. A high quality image with sufficient reproducibility of a fine line was obtained over a long period of time without fogging.

### EXAMPLE 17

| | | |
|---|---|---|
| Styrene-acrylic copolymer resin (acid value: | 91 | parts |
| 0.1) (CPR-100, tradename, manufactured | | |
| by Mitsui Chemical Co., Ltd.) | | |
| Charge control agent | 1 | part |
| Zirconium compound (Compound No. 1) | (0.50 | part) |
| Spilonblack TRH (tradename, manufactured | (0.50 | part) |
| by Hodogaya Chemical Co., Ltd.) | | |
| Carbon black (MA-100, tradename, | 5 | parts |
| manufactured by Mitsubishi Chemical | | |
| Corporation) | | |
| Low molecular weight polypropylene | 3 | parts |
| (Biscoal 550P, tradename, manufactured | | |
| by Sanyo Kasei K.K.) | | |

The above mixture was melted and kneaded by a heat-mixing apparatus at 140° C., and the mixture was cooled and roughly pulverized by a hammer mill. It was further finely s pulverized by a jet mill and then classified to obtain a black toner having a particle size of from 10 to 12 μm.

This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus. Further, the electrification rising property was compared by the time constant. Further, an image test by a modified commercial copying machine was also carried out. The results are shown in Table 3. The electrification rising property was excellent, and a sufficient image density was obtained under all conditions. A high quality image with sufficient reproducibility of a fine line was obtained over a long period of time without fogging.

### EXAMPLE 18

| | | |
|---|---|---|
| Styrene-acrylic copolymer resin (acid value: | 91 | parts |
| 0.1) (CPR-100, tradename, manufactured | | |
| by Mitsui Chemical Co., Ltd.) | | |
| Charge control agent | 1 | part |
| Zirconium compound (Compound No. 1) | (0.80 | part) |
| Spilonblack TRH (tradename, manufactured | (0.20 | part) |
| by Hodogaya Chemical Co., Ltd) | | |
| Carbon black (MA-100, tradename, | 5 | parts |
| manufactured by Mitsubishi Chemical | | |
| Corporation) | | |
| Low molecular weight polypropylene | 3 | parts |
| (Biscoal 550P, tradename, manufactured | | |
| by Sanyo Kasei K.K.) | | |

The above mixture was melted and kneaded by a heat-mixing apparatus at 140° C., and the mixture was cooled and roughly pulverized by a hammer mill. It was further finely pulverized by a jet mill and then classified to obtain a black toner having a particle size of from 10 to 12 μm. This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus. Further, the electrification rising property was compared by the time constant. Further, an image test by a modified commercial copying machine was also carried out. The results are shown in Table 3. The electrification rising property was excellent, and a sufficient image density was obtained under all conditions. A high quality image with sufficient reproducibility of a fine line was obtained over a long period of time without fogging.

### EXAMPLE 19

| | | |
|---|---|---|
| Styrene-acrylic copolymer resin (acid value: | 91 | parts |
| 0.1) (CPR-100, tradename, manufactured | | |
| by Mitsui Chemical Co., Ltd.) | | |
| Charge control agent | 1 | part |
| Zirconium compound (Compound No. 1) | (0.05 | part) |
| T-95 (tradename, manufactured by | (0.95 | part) |
| Hodogaya Chemical Co., Ltd.) | | |
| Carbon black (MA-100, tradename, | 5 | parts |
| manufactured by Mitsubishi Chemical | | |
| Corporation) | | |
| Low molecular weight polypropylene | 3 | parts |
| (Biscoal 550P, tradename, manufactured | | |
| by Sanyo Kasei K.K.) | | |

The above mixture was melted and kneaded by a heat-mixing apparatus at 140° C., and the mixture was cooled and roughly pulverized by a hammer mill. It was further finely pulverized by a jet mill and then classified to obtain a black toner having a particle size of from 10 to 12 μm, This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus. Further, the electrification rising property was compared by the time constant. Further, an image test by a modified commercial copying machine was also carried out. The results are shown in Table 3. The electrification rising property was excellent, and a sufficient image density was obtained under all conditions. A high quality image with sufficient reproducibility of a fine line was obtained over a long period of time without fogging.

### EXAMPLE 20

| | | |
|---|---|---|
| Styrene-acrylic copolymer resin (acid value: | 91 | parts |
| 0.1) (CPR-100, tradename, manufactured | | |
| by Mitsui Chemical Co., Ltd.) | | |
| Charge control agent | 1 | part |
| Zirconium compound (Compound No. 1) | (0.10 | part) |
| T-95 (tradename, manufactured by | (0.90 | part) |
| Hodogaya Chemical Co., Ltd.) | | |
| Carbon black (MA-100, tradename, | 5 | parts |
| manufactured by Mitsubishi Chemical | | |
| Corporation) | | |
| Low molecular weight polypropylene | 3 | parts |
| (Biscoal 550P, tradename, manufactured | | |
| by Sanyo Kasei K.K.) | | |

The above mixture was melted and kneaded by a heat-mixing apparatus at 140° C., and the mixture was cooled and roughly pulverized by a hammer mill. It was further finely pulverized by a jet mill and then classified to obtain a black toner having a particle size of from 10 to 12 μm. This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus. Further, the electrification rising property was compared by the time constant. Further, an image test by a modified commercial copying machine was also carried out. The results are shown in Table 3. The electrification rising property was excellent, and a sufficient image density was obtained under all conditions. A high quality image with sufficient reproducibility of a fine line was obtained over a long period of time without fogging.

### EXAMPLE 21

| | | |
|---|---|---|
| Styrene-acrylic copolymer resin (acid value; | 91 | parts |
| 0.1) (CPR-100, tradename, manufactured | | |
| by Mitsui Chemical Co., Ltd.) | | |
| Charge control agent | 1 | part |
| Zirconium compound. (Compound No. 1) | (0.50 | part) |
| T-95 (tradename, manufactured by | (0.50 | part) |
| Hodogaya Chemical Co., Ltd.) | | |
| Carbon black (MA-100, tradename, | 5 | parts |
| manufactured by Mitsubishi Chemical | | |
| Corporation) | | |
| Low molecular weight polypropylene | 3 | parts |
| (Biscoal 550P, tradename, manufactured | | |
| by Sanyo Kasei K.K.) | | |

The above mixture was melted and kneaded by a heat-mixing apparatus at 140° C., and the mixture was cooled and roughly pulverized by a hammer mill. It was further finely pulverized by a jet mill and then classified to obtain a black toner having a particle size of from 10 to 12 μm. This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus. Further, the electrification rising property was compared by the time constant. Further, an image test by a modified commercial copying machine was also carried out. The results are shown in Table 3. The electrification rising property was excellent, and a sufficient image density was obtained under all conditions. A high quality image with sufficient reproducibility of a fine line was obtained over a long period of time without fogging.

### EXAMPLE 22

| | | |
|---|---|---|
| Styrene-acrylic copolymer resin (acid value: | 91 | parts |
| 0.1) (CPR-100, tradename, manufactured | | |
| by Mitsui Chemical Co., Ltd.) | | |
| Charge control agent | 1 | part |
| Zirconium compound (Compound No. 1) | (0.80 | part) |
| T-95 (tradename, manufactured by | (0.20 | part) |
| Hodogaya Chemical Co., Ltd.) | | |
| Carbon black (MA-100, tradename, | 5 | parts |
| manufactured by Mitsubishi Chemical | | |
| Corporation) | | |
| Low molecular weight polypropylene | 3 | parts |
| (Biscoal 550P, tradename, manufactured | | |
| by Sanyo Kasei K.K.) | | |

The above mixture was melted and kneaded by a heat-mixing apparatus at 140° C., and the mixture was cooled and roughly pulverized by a hammer mill. It was further finely pulverized by a jet mill and then classified to obtain a black toner having a particle size of from 10 to 12 μm. This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus. Further, the electrification rising property was compared by the time constant. Further, an image test by a modified commercial copying machine was also carried out. The results are shown in Table 3. The electrification rising property was excellent, and a sufficient image density was obtained under all conditions. A high quality image with sufficient reproducibility of a fine line was obtained over a long period of time without fogging.

### COMPARATIVE EXAMPLE 8

| | | |
|---|---|---|
| Styrene-acrylic copolymer resin (acid value: | 91 | parts |
| 0.1) (CPR-100, tradename, manufactured | | |
| by Mitsui Chemical Co., Ltd.) | | |
| Zirconium compound (Compound No. 1) | 1.0 | part |
| Carbon black (MA-100, tradename, | 5 | parts |
| manufactured by Mitsubishi Chemical | | |
| Corporation) | | |
| Low molecular weight polypropylene | 3 | parts |
| (Biscoal 550P, tradename, manufactured | | |
| by Sanyo Kasei K.K.) | | |

The above mixture was melted and kneaded by a heat-mixing apparatus at 140° C., and the mixture was cooled and roughly pulverized by a hammer mill. It was further finely pulverized by a jet mill and then classified to obtain a black toner having a particle size of from 10 to 12 μm.

This toner was mixed with a silicon coated ferrite carrier (F96-100, tradename, manufactured by Powder Tech Co.) in a weight ratio of 4:100, and the mixture was shaked to negatively electrify the toner. Then, the charge was imeasured by a blow off charge measuring apparatus. Further, the electrification rising property was compared by the time constant. Further, an image test by a modified commercial copying machine was also carried out. The results are shown in Table 3. The electrification rising property was good, but no adequate image density was obtained when 50,000 sheets were copied.

### COMPARATIVE EXAMPLE 9

| | | |
|---|---|---|
| Styrene-acrylic copolymer resin (acid value: | 91 | parts |
| 0.1) (CPR-100, tradename, manufactured | | |
| by Mitsui Chemical Co., Ltd.) | | |
| Charge control agent (T-77, tradename, | 1.0 | part |
| manufactured by Hodogaya Chemical | | |
| Co., Ltd.) | | |
| Carbon black (MA-100, tradename, | 5 | parts |
| manufactured, by Mitsubishi Chemical | | |
| Corporation) | | |
| Low molecular weight polypropylene | 3 | parts |
| (Biscoal 550P, tradename, manufactured | | |
| by Sanyo Kasei K.K.) | | |

The above mixture containing only T-77 as the charge control agent was melted and kneaded by a heat-mixing apparatus at 140° C., and the mixture was cooled and roughly pulverized by a hammer mill. It was further finely pulverized by a jet mill and then classified to obtain a black toner having a particle size of from 10 to 12 μm. This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus. Further, the electrification rising property was compared by the time constant. Further, an image test by a modified commercial copying machine was also carried out. The results are shown in Table 3. The electrification rising property was poor, and no adequate image density was obtained at the initial stage of printing.

### COMPARATIVE EXAMPLE 10

| | | |
|---|---|---|
| Styrene-acrylic copolymer resin (acid value: | 91 | parts |
| 0.1) (CPR-100, tradename, manufactured | | |
| by Mitsui Chemical Co., Ltd.) | | |
| Charge control agent (Spilonblack TRH, | 1.0 | part |
| tradename, manufactured by Hodogaya | | |
| Chemical Co., Ltd.) | | |
| Carbon black (MA-100, tradename, | 5 | parts |
| manufactured by Mitsubishi Chemical | | |
| Corporation) | | |
| Low molecular weight polypropylene | 3 | parts |
| (Biscoal 550P, tradename, manufactured | | |
| by Sanyo Kasei K.K.) | | |

The above mixture containing only Spilonblack TRH as the charge control agent was melted and kneaded by a heat-mixing apparatus at 140° C., and the mixture was cooled and roughly pulverized by a hammer mill. It was further finely pulverized by a jet mill and then classified to obtain a black toner having a particle size of from 10 to 12 μm. This toner was mixed with a silicon coated ferrite carrier (P96-100, tradename, manufactured by Powder Tech Co.) in a weight ratio of 4:100, and the mixture was shaked to negatively electrify the toner. Then, the charge was measured by a blow off charge measuring apparatus. Further, the electrification rising property was compared by the time constant. Further, an image test by a modified commercial copying machine was also carried out. The results are shown in Table 3. The electrification rising property was poor, and no adequate image density was obtained at the initial stage of printing.

### COMPARATIVE EXAMPLE 11

| | |
|---|---|
| Styrene-acrylic copolymer resin (acid value: | 91 parts |
| 0.1) (CPR-100, tradename, manufactured | |
| by Mitsui Chemical Co., Ltd.) | |
| Charge control agent (T-95, tradename, | 1.0 part |
| manufactured by Hodogaya Chemical | |
| Co., Ltd.) | |
| Carbon black (MA-100, tradename, | 5 parts |
| manufactured by Mitsubishi Chemical | |
| Corporation) | |
| Low molecular weight polypropylene | 3 parts |
| (Biscoal 550P, tradename, manufactured | |
| by Sanyo Kasei K.K.) | |

The above mixture containing only T-95 as the charge control agent was melted and kneaded by a heat-mixing apparatus at 140° C., and the mixture was cooled and roughly pulverized by a hammer mill. It was further finely pulverized by a jet mill and then classified to obtain a black toner having a particle size of from 10 to 12 μm. This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus. Further, the electrification rising property was compared by the time constant. Further, an image test by a modified commercial copying machine was also carried out. The results are shown in Table 3. The electrification rising property was poor, and no adequate image density was obtained at the initial stage of printing.

### COMPARATIVE EXAMPLE 12

| | |
|---|---|
| Styrene-acrylic copolymer resin (acid value: | 91 parts |
| 0.1) (CPR-100, tradename, manufactured | |
| by Mitsui Chemical Co., Ltd.) | |
| Charge control agent | 1 part |
| Zirconium compound (Compound No. 1) | (0.03 part) |
| T-77 (tradename, manufactured by | (0.97 part) |
| Hodogaya Chemical Co., Ltd.) | |
| Carbon black (MA-100, tradename, | 5 parts |
| manufactured by Mitsubishi Chemical | |
| Corporation) | |
| Low molecular weight polypropylene | 3 parts |
| (Biscoal 550P, tradename, manufactured | |
| by Sanyo Kasei K.K.) | |

The above mixture was melted and kneaded by a heat-mixing apparatus at 140° C., and the mixture was cooled and roughly pulverized by a hammer mill. It was further finely pulverized by a jet mill and then classified to obtain a black toner having a particle size of from 10 to 12 μm. This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus. Further, the electrification rising property was compared by the time constant. Further, an image test by a modified commercial copying machine was also carried out. The results are shown in Table 3. The electrification rising property was poor, and no adequate image density was obtained at the initial stage of printing.

### COMPARATIVE EXAMPLE 13

| | |
|---|---|
| Styrene-acrylic copolymer resin (acid value: | 91 parts |
| 0.1) (CPR-100, tradename, manufactured | |
| by Mitsui Chemical Co., Ltd.) | |
| Charge control agent | 1 part |
| Zirconium compound (Compound No. 1) | (0.85 part) |
| T-77 (tradename, manufactured by | (0.15 part) |
| Hodogaya Chemical Co., Ltd.) | |
| Carbon black (MA-100, tradename, | 5 parts |
| manufactured by Mitsubishi Chemical | |
| Corporation) | |
| Low molecular weight polypropylene | 3 parts |
| (Biscoal 550P, tradename, manufactured | |
| by Sanyo Kasei K.K.) | |

The above mixture was melted and kneaded by a heat-mixing apparatus at 140° C., and the mixture was cooled and roughly pulverized by a hammer mill, It was further finely pulverized by a jet mill and then classified to obtain a black toner having a particle size of from 10 to 12 μm. This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus. Further, the electrification rising property was compared by the time constant. Further, an image test by a modified commercial copying machine was also carried out. The results are shown in Table 3. The electrification rising property was poor, and no adequate image density was obtained at the initial stage of printing.

TABLE 3

| | | | Evaluation of toner | | | | | | |
|---|---|---|---|---|---|---|---|---|---|
| | Charge | Charge | Charge (μC/g) | | | Image quality | | | Fogging |
| | control | control | Time | | After | | After | Environ- | Scatter- |
| Example | agent 1 | agent 2 | constant | | 50,000 | | 50,000 | mental | ing of |
| No. | (parts) | (parts) | (sec.) | Initial | sheets | Initial | sheets | stability | toner |
| 11 | Comp. No. 1 | T-77 | 33.3 | −13.8 | −13.8 | ∘ | ∘ | ∘ | ∘ |
| | (0.05) | (0.95) | | | | | | | ∘ |
| 12 | Comp. No. 1 | T-77 | 27.5 | −15.2 | −15.5 | ∘ | ∘ | ∘ | ∘ |
| | (0.10) | (0.90) | | | | | | | ∘ |
| 13 | Comp. No. 1 | T-77 | 23.3 | −22.8 | −23.6 | ∘ | ∘ | ∘ | ∘ |
| | (0.50) | (0.50) | | | | | | | ∘ |
| 14 | Comp. No. 1 | T-77 | 21.1 | −23.5 | −25.4 | ∘ | ∘ | ∘ | ∘ |
| | (0.80) | (0.20) | | | | | | | ∘ |
| 15 | Comp. No. 1 | TRH | 30.3 | −15.3 | −15.8 | ∘ | ∘ | ∘ | ∘ |
| | (0.05) | (0.95) | | | | | | | ∘ |
| 16 | Comp. No. 1 | TRH | 23.5 | −17.2 | −17.5 | ∘ | ∘ | ∘ | ∘ |
| | (0.10) | (0.90) | | | | | | | ∘ |
| 17 | Comp No. 1 | TRH | 17.3 | −23.8 | −23.6 | ∘ | ∘ | ∘ | ∘ |
| | (0.50) | (0.50) | | | | | | | ∘ |
| 18 | Comp. No. 2 | TRH | 16.4 | −24.5 | −25.6 | ∘ | ∘ | ∘ | ∘ |
| | (0.80) | (0.20) | | | | | | | ∘ |
| 19 | Comp. No. 1 | T-95 | 31.3 | −11.8 | −10.9 | ∘ | ∘ | ∘ | ∘ |
| | (0.05) | (0.95) | | | | | | | ∘ |
| 20 | Comp. No. 1 | T-95 | 22.3 | −12.2 | −12.5 | ∘ | ∘ | ∘ | ∘ |
| | (0.10) | (0.90) | | | | | | | ∘ |
| 21 | Comp. No. 1 | T-95 | 18.3 | −22.0 | −22.6 | ∘ | ∘ | ∘ | ∘ |
| | (0.50) | (0.50) | | | | | | | ∘ |
| 22 | Comp. No. 1 | T-95 | 15.3 | −23.1 | −24.4 | ∘ | ∘ | ∘ | ∘ |
| | (0.80) | (0.20) | | | | | | | ∘ |
| Comp. | Comp. No. 1 | — | 15.9 | −24.3 | −27.1 | ∘ | Δ | ∘ | Δ |
| Ex. 8 | (1.0) | | | | | | | | Δ |
| Comp. | T-77 | — | 197 | −12.7 | −12.6 | Δ | ∘ | ∘ | ∘ |
| Ex. 9 | (1.0) | | | | | | | | ∘ |
| Comp. | TRH | — | 165 | −14.7 | −14.6 | Δ | ∘ | ∘ | ∘ |
| Ex. 10 | (1.0) | | | | | | | | ∘ |
| Comp. | T-95 | — | 178 | −11.7 | −11.9 | Δ | ∘ | ∘ | ∘ |
| Ex. 11 | (1.0) | | | | | | | | ∘ |
| Comp. | Comp. No. 1 | T-77 | 87.1 | −12.9 | −12.6 | Δ | ∘ | ∘ | ∘ |
| Ex. 12 | (0.03) | (0.97) | | | | | | | ∘ |
| Comp. | Comp. No. 1 | T-77 | 13.3 | −23.7 | −26.6 | ∘ | Δ | ∘ | ∘ |
| Ex. 13 | (0.85) | (0.15) | | | | | | | ∘ |

In the evaluation of image quality, symbol ∘ represents “sufficient image quality”, and symbol Δ represents “fair image quality”. In the evaluation of environmental stability, symbol ∘ represents “safe”. In the evaluation of fogging or scattering of toner, symbol ∘ represents “no fogging or scattering of toner”, and symbol Δ represents “slight fogging or slight scattering of toner”. Magnetic toner

### EXAMPLE 23

| | |
|---|---|
| Styrene-acrylic copolymer resin (acid value: | 100 parts |
| 0.1) (CPR-100, tradename, manufactured | |
| by Mitsui Chemical Co., Ltd.) | |
| Zirconium compound (Compound No. 1) | 2 parts |
| magnetic powder (average particle size: | 80 parts |
| 0.2 μm, coercive force: 60 oersted) | |
| (MA-100, tradename, manufactured by | |
| Mitsubishi Chemical Corporation) | |
| Low molecular weight polypropylene | 3 parts |
| (Biscoal 550P, tradename, manufactured | |
| by Sanyo Kasei K.K.) | |

The above mixture was melted and kneaded by a heat-mixing apparatus at 140° C., and the mixture was cooled and roughly pulverized by a hammer mill. It was further finely pulverized and then classified to obtain a black toner having a particle size of from 10 to 12 μm. The saturation magnetization of this toner was 28 Am²/kg, and the coercive force was 60 oersted. This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus. Further, an image test by a modified commercial copying machine was also carried out. The results are shown in Table 4. The electrification rising property was excellent, and a sufficient image density was obtained under all conditions. A high quality image with sufficient reproducibility of fine lines was obtained over a long period of time without fogging.

### EXAMPLE 24

| | |
|---|---|
| Styrene-acrylic copolymer resin (acid value: | 100 parts |
| 0.1) (CPR-100, tradename, manufactured | |
| by Mitsui Chemical Co., Ltd.) | |
| Zirconium compound (Compound No. 1) | 2 parts |
| Magnetic powder (average particle size: | 80 parts |
| 0.2 μm, coercive force: 90 oersted) | |
| (MA-100, tradename, manufactured by | |
| Mitsubishi Chemical Corporation) | |
| Low molecular weight polypropylene | 3 parts |
| (Biscoal 550P, tradename, manufactured | |
| by Sanyo Kasei K.K.) | |

The above mixture was melted and kneaded by a heat-mixing apparatus at 140° C., and the mixture was cooled and roughly pulverized by a hammer mill. It was further finely pulverized and then classified to obtain a black toner having a particle size of from 10 to 12 μm. The saturation magnetization of this toner was 28 Am²/kg, and the coercive force was 90 oersted. This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus. Further, an image test by a modified commercial copying machine was also carried out. The results are shown in Table 4. The electrification rising property was excellent, and a sufficient image density was obtained under all conditions. A high quality image with sufficient reproducibility of fine lines was obtained over a long period of time without fogging.

### EXAMPLE 25

| | |
|---|---|
| Styrene-acrylic copolymer resin (acid value: | 100 parts |
| 0.1) (CPR-100, tradename, manufactured | |
| by Mitsui Chemical Co., Ltd.) | |
| Zirconium compound (Compound No. 1) | 2 parts |
| Magnetic powder (average particle size: | 80 parts |
| 0.2 μm, coercive force: 140 oersted) | |
| (MA-100, tradename, manufactured by | |
| Mitsubishi Chemical Corporation) | |
| Low molecular weight polypropylene | 3 parts |
| (Biscoal. 550P, tradename, manufactured | |
| by Sanyo Kasei K.K.) | |

The above mixture was melted and kneaded by a heat-mixing apparatus at 140° C., and the mixture was cooled and roughly pulverized by a hammer mill. It was further finely pulverized and then classified to obtain a black toner having a particle size of from 10 to 12 μm. The saturation magnetization of this toner was 28 Am²/kg, and the coercive force was 140 oersted. This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus. Further, an image test by a modified commercial copying machine was also carried out. The results are shown in Table 4. The electrification rising property was excellent, and a sufficient image density was obtained under all conditions. A high quality image with sufficient reproducibility of fine lines was obtained over a long period of time without fogging.

### EXAMPLE 26

| | |
|---|---|
| Styrene-acrylic copolymer resin (acid value: | 100 parts |
| 0.1) (CPR-100, tradename, manufactured | |
| by Mitsui Chemical Co., Ltd.) | |
| Zirconium compound (Compound No. 1) | 1 parts |
| Magnetic powder (average particle size: | 80 parts |
| 0.2 μm, coercive force: 180 oersted) | |
| (MA-100, tradename, manufactured by | |
| Mitsubishi Chemical Corporation) | |
| Low molecular weight polypropylene | 3 parts |
| (Biscoal 550P, tradename, manufactured | |
| by Sanyo Kasei K.K.) | |

The above mixture was melted and kneaded by a heat-mixing apparatus at 140° C., and the mixture was cooled and roughly pulverized by a hammer mill. It was further finely pulverized and then classified to obtain a black toner having a particle size of from 10 to 12 μm. The saturation magnetization of this toner was 28 Am²/kg, and the coercive force was 180 oersted. This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus. Further, an image test by a modified commercial copying machine was also carried out. The results are shown in Table 4. The electrification rising property was excellent, and a sufficient image density was obtained under all conditions. A high quality image with sufficient reproducibility of fine lines was obtained over a long period of time without fogging.

### EXAMPLE 27

| | |
|---|---|
| Styrene-acrylic copolymer resin (acid value: | 100 parts |
| 0.1) (CPR-100, tradename, manufactured | |
| by Mitsui Chemical Co,, Ltd.) | |
| Zirconium compound (Compound No. 1) | 2 parts |
| Magnetic powder (average particle size: | 100 parts |
| 0.2 μm, coercive forces 140 oersted) | |
| (MA-100, tradename, manufactured by | |
| Mitsubishi Chemical Corporation) | |
| Low molecular weight polypropylene | 3 parts |
| (Biscoal 550P, tradename, manufactured | |
| by Sanyo Kasei K.K.) | |

The above mixture was melted and kneaded by a heat-mixing apparatus at 140° C., and the mixture was cooled and roughly pulverized by a hammer mill. It was further finely pulverized and then classified to obtain a black toner having a particle size of from 10 to 12 μm. The saturation magnetization of this toner was 32 Am²/kg, and the coercive force was 140 oersted. This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus. Further, an image test by a modified commercial copying machine was also carried out. The results are shown in Table 4. The electrification rising property was excellent, and a sufficient image density was obtained under all conditions. A high quality image with sufficient reproducibility of fine lines was obtained over a long period of time without fogging.

### EXAMPLE 28

| | |
|---|---|
| Styrene-acrylic copolymer resin (acid value: | 100 parts |
| 0.1) (CPR-100, tradename, manufactured | |
| by Mitsui Chemical Co., Ltd.) | |
| Zirconium compound (Compound No. 1) | 2 parts |
| Magnetic powder (average particle size: | 120 parts |
| 0.2 μm, coercive force: 140 oersted) | |
| (MA-100, tradename, manufactured by | |
| Mitsubishi Chemical Corporation) | |
| Low molecular weight polypropylene | 3 parts |
| (Biscoal 550P, tradename, manufactured | |
| by Sanyo Kasei K.K.) | |

The above mixture was melted and kneaded by a heat-mixing apparatus at 140° C., and the mixture was cooled and roughly pulverized by a hammer mill. It was further finely pulverized and then classified to obtain a black toner having a particle size of from 10 to 12 μm. The saturation magnetization of this toner was 36 Am²/kg, and the coercive force was 140 oersted. This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus. Further, an image test by a modified commercial copying machine was also carried out. The results are shown in Table 4. The electrification rising property was excellent, and a sufficient image density was obtained under all conditions. A high quality image with sufficient reproducibility of fine lines was obtained over a long period of time without fogging.

### EXAMPLE 29

| | |
|---|---|
| Styrene-acrylic copolymer resin (acid value: | 100 parts |
| 0.1) (CPR-100, tradename, manufactured | |
| by Mitsui Chemical Co., Ltd.) | |
| Zirconium compound (Compound No. 1) | 2 parts |
| Magnetic powder (average particle size: | 100 parts |
| 0.2 μm, coercive force: 90 oersted) | |
| (MA-100, tradename, manufactured by | |
| Mitsubishi Chemical Corporation) | |
| Low molecular weight polypropylene | 3 parts |
| (Biscoal 550P, tradename, manufactured | |
| by Sanyo Kasei K.K.) | |

The above mixture was melted and kneaded by a heat-mixing apparatus at 140° C., and the mixture was cooled and roughly pulverized by a hammer mill. It was further finely pulverized and then classified to obtain a black toner having a particle size of from 10 to 12 μm. The saturation magnetization of this toner was 32 Am²/kg, and the coercive force was 90 oersted. This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus. Further, an image test by a modified commercial copying machine was also carried out. The results are shown in Table 4. The electrification rising property was excellent, and a sufficient image density was obtained under all conditions. A high quality image with sufficient reproducibility of fine lines was obtained over a long period of time without fogging.

### EXAMPLE 30

| | |
|---|---|
| Styrene-acrylic copolymer resin (acid value: | 100 parts |
| 0.1) (CPR-100, tradename, manufactured | |
| by Mitsui Chemical Co., Ltd.) | |
| Zirconium compound (Compound No. 1) | 2 parts |
| Magnetic powder (average particle size: | 120 parts |
| 0.2 μm, coercive force: 90 oersted) | |
| (MA-100, tradename, manufactured by | |
| Mitsubishi Chemical Corporation) | |
| Low molecular weight polypropylene | 3 parts |
| (Biscoal 550P, tradename, manufactured | |
| by Sanyo Kasei K.K.) | |

The above mixture was melted and kneaded by a heat-mixing apparatus at 140° C., and the mixture was cooled and roughly pulverized by a hammer mill. It was further finely pulverized and then classified to obtain a black toner having a particle size of from 10 to 12 μm. The saturation magnetization of this toner was 36 Am²/kg, and the coercive force was 90 oersted. This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus. Further, an image test by a modified commercial copying machine was also carried out. The results are shown in Table 4. The electrification rising property was excellent, and a sufficient image density was obtained under all conditions. A high quality image with sufficient reproducibility of fine lines was obtained over a long period of time without fogging.

### COMPARATIVE EXAMPLE 14

| | |
|---|---|
| Styrene-acrylic copolymer resin (acid value: | 100 parts |
| 0.1) (CPR-100, tradename, manufactured | |
| by Mitsui Chemical Co., Ltd.) | |
| Zirconium compound (Compound No. 1) | 2 parts |
| Magnetic powder (average particle size: | 80 parts |
| 0.2 μm, coercive force: 300 oersted) | |
| (MA-100, tradename, manufactured by | |
| Mitsubishi Chemical Corporation) | |
| Low molecular weight polypropylene | 3 parts |
| (Biscoal 550P, tradename, manufactured | |
| by Sanyo Kasei K.K.) | |

The above mixture was melted and kneaded by a heat-mixing apparatus at 140° C., and the mixture was cooled and roughly pulverized by a hammer mill. It was further finely pulverized and then classified to obtain a black toner having a particle size of from 10 to 12 μm. The saturation magnetization of this toner was 28 Am²/kg, and the coercive force was 300 oersted. This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus. Further, an image test by a modified commercial copying machine was also carried out. The results are shown in Table 4. By repeated printing operation for a long period of time, a decrease in the image density was observed. Further, at the same time, fogging was observed, and a distinct image deterioration was observed.

### COMPARATIVE EXAMPLE 15

| | |
|---|---|
| Styrene-acrylic copolymer resin (acid value: | 100 parts |
| 0.1) (CPR-100, tradename, manufactured | |
| by Mitsui Chemical Co., Ltd.) | |
| Zirconium compound (Compound No. 1) | 2 parts |
| Magnetic powder (average particle size: | 150 parts |
| 0.2 μm, coercive force: 90 oersted) | |
| (MA-100, tradename, manufactured by | |
| Mitsubishi Chemical Corporation) | |
| Low molecular weight polypropylene | 3 parts |
| (Biscoal 550P, tradename, manufactured | |
| by Sanyo Kasei K.K.) | |

The above mixture was melted and kneaded by a heat-mixing apparatus at 140° C., and the mixture was cooled and roughly pulverized by a hammer mill. It wag further finely pulverized and then classified to obtain a black toner having a particle size of from 10 to 12 μm. The saturation magnetization of this toner was 52 Am²/kg, and the coercive force was 90 oersted. This toner was mixed with a silicon coated ferrite carrier (F96-100, tradename, manufactured by Powder Tech Co.) in a weight ratio of 4:100, and the mixture was shaked to negatively electrify the toner. Then, the charge was measured by a blow off charge measuring apparatus. Further, an image test by a modified commercial copying machine was also carried out. The results are shown in Table 4. From the image of the initial stage, formation of a ghost due to fixing failure or soiling of the fixing roller was observed. Further, by repeated printing operation for a long period of time, the image density decreased. At the same time, fogging was observed, and a distinct image deterioration was observed.

TABLE 4

| | | | Evaluation of toner | | | | | |
|---|---|---|---|---|---|---|---|---|
| | | | Charge (μC/g) | | Image quality | | | Fogging |
| | | | | After | | After | | Scatter- |
| Example | Saturation | Coercive | | 50,000 | | 50,000 | Fixing | ring of |
| No. | magnetization | force | Initial | sheets | Initial | sheets | property | toner |
| 23 | 28 | 60 | −18.0 | −18.2 | ∘ | ∘ | ∘ | ∘ |
| | | | | | | | | ∘ |
| 24 | 28 | 90 | −17.6 | −17.5 | ∘ | ∘ | ∘ | ∘ |
| | | | | | | | | ∘ |
| 25 | 28 | 140 | −18.5 | −18.2 | ∘ | ∘ | ∘ | ∘ |
| | | | | | | | | ∘ |
| 26 | 28 | 180 | −19.7 | −21.2 | ∘ | ∘ | ∘ | ∘ |
| | | | | | | | | ∘ |
| 27 | 32 | 140 | −16.5 | −15.4 | ∘ | ∘ | ∘ | ∘ |
| | | | | | | | | ∘ |
| 28 | 36 | 140 | −15.6 | −15.3 | ∘ | ∘ | ∘ | ∘ |
| | | | | | | | | ∘ |
| 29 | 32 | 90 | −16.8 | −16.8 | ∘ | ∘ | ∘ | ∘ |
| | | | | | | | | ∘ |
| 30 | 36 | 90 | −15.2 | −15.6 | ∘ | ∘ | ∘ | ∘ |
| | | | | | | | | ∘ |
| Comp. | 28 | 300 | −19.2 | −23.5 | ∘ | X | X | Δ |
| Ex. 14 | | | | | | | | Δ |
| Comp. | 52 | 90 | −13.4 | −12.7 | X | X | ∘ | X |
| Ex. 15 | | | | | | | | X |

In the evaluation of image quality, symbol ∘ represents “sufficient image quality”, and symbol × represents “insufficient image quality”. In the evaluation of fixing property, symbol ∘ represents “good fixing property”, and symbol × represents “poor fixing property”.

In the evaluation of fogging or scattering of toner, symbol ∘ represents “no fogging or scattering of toner”, symbol Δ represents “slight fogging or slight scattering of toner”, and symbol × represents “substantial fogging or substantial scattering of toner”.

The zirconium compound of the formula (1) to be used in the present invention is a colorless or slightly colored thermally stable compound which can be uniformly dispersed in a binder resin, and thus it always presents an image of high quality even when it is used in a recycling system.

Further, the zirconium compound of the formula (1) to be used in the present invention is a colorless or slightly colored highly stable compound, and by using it in combination with a specific azo metal complex, it is possible to present an electrostatic image developing toner having an extremely quick electrification rising property, whereby it is possible to always present an image of high quality from the initial stage of printing.

Furthermore, by the magnetic toner employing the zirconium compound of the formula (1) to be used in the present invention, it has been made possible to present an electrostatic image developing toner which is excellent in the electrification rising property and which is capable of presenting an image of a sufficient image quality under all conditions .

What is claimed is:

1. An electrostatic image developing toner to be used for an image forming method wherein in an electrophotographic process of forming an electrostatic latent image on a photoreceptor made of an inorganic or organic material, developing it with a toner, transferring it to a paper sheet, a plastic film or the like, and fixing it to form a visible image, the toner remaining on the photoreceptor after the transfer, is recovered, and the recovered toner is reused in the development process, said electrostatic image developing toner comprising at least a binder resin, a colorant and a charge control agent, wherein the charge control agent is represented by the following formula (1): 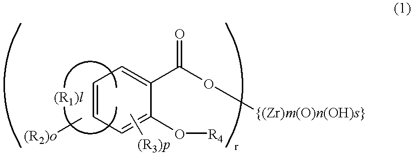
wherein R₁ is quaternary carbon, methine or methylene and may contain a hetero atom of N, S, O or P, each of R₂ and R₃ which are independent of each other, is an alkyl group, an alkenyl group, an alkoxy group, an aryl, aryloxy, aralkyl or aralkyloxy group which may have a substituent, a halogen atom, a hydrogen atom, a hydroxyl group, an amino group which may have a substituent, a carboxyl group, a carbonyl group, a nitro group, a nitroso group, a sulfonyl group or a cyano group, R₄ is a hydrogen atom or an alkyl group, l is an integer of from 0 to 12, m is an integer of from 1 to 20, n is an integer of from 0 to 20, o is an integer of from 0 to 4, p is an integer of from 0 to 4, r is an integer of from 1 to 20, and s is an integer of from 0 to 20.

2. The electrostatic image developing toner according to claim 1, wherein the binder resin is a polymer or copolymer made of a monomer selected from the group consisting of styrene type monomers, acrylic monomers and methacrylic monomers.

3. The electrostatic image developing toner according to claim 1, wherein the binder resin is a polyester comprising at least one alcohol component selected from the group consisting of dihydric and polyhydric alcohols and at least one acid component selected from the group consisting of dicarboxylic and polycarboxylic acids and their anhydrides.

4. The electrostatic image developing toner according to claim 1, wherein the binder resin has a glass transition point of from 40 to 90° C., a number average molecular weight (Mn) of from 1,500 to 50,000 and a weight average molecular weight (Mw) of from 10,000 to 3,000,000.

5. The electrostatic image developing toner according to claim 1, wherein the binder resin has a hydroxyl value of at most 50 and an acid value of at most 50.

6. The electrostatic image developing toner according to claim 1, wherein the toner contains a magnetic powder.

7. The electrostatic image developing toner according to claim 1, wherein the charge control agent of the formula (1) is contained in an amount within a range of from 0.01 to 10 parts by weight per 100 parts by weight of the binder resin, and the average particle size of the toner is within a range of from 0.01 to 10 μm.

8. An electrostatic image developing toner comprising at least a binder resin, a colorant and a charge control agent, wherein the charge control agent comprises at least one zirconium compound of the following formula (1) and at least one specific azo metal complex: 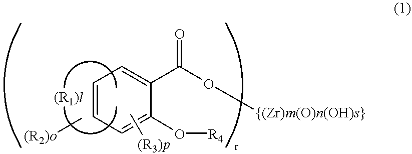
wherein R₁ is quaternary carbon, methine or methylene and may contain a hetero atom of N, S, O or P, each of R₂ and R₃ which are independent of each other, is an alkyl group, an alkenyl group, an alkoxy group, an aryl, aryloxy, aralkyl or aralkyloxy group which may have a substituent, a halogen atom, a hydrogen atom, a hydroxyl group, an amino group which may have a substituent, a carboxyl group, a carbonyl group, a nitro group, a nitroso group, a sulfonyl group or a cyano group, R₄ is a hydrogen atom or an alkyl group, l is an integer of from 0 to 12, m is an integer of from 1 to 20, n is an integer of from 0 to 20, o is an integer of from 0 to 4, p is an integer of from 0 to 4, r is an integer of from 1 to 20, and s is an integer of from 0 to 20.

9. The electrostatic image developing toner according to claim 8, wherein the binder resin is a polymer or copolymer made of a monomer selected from the group consisting of styrene type monomers, acrylic monomers and methacrylic monomers.

10. The electrostatic image developing toner according to claim 8, wherein the binder resin is a polyester comprising at least one alcohol component selected from the group consisting of dihydric and polyhydric alcohols and at least one acid component selected from the group consisting of dicarboxylic and polycarboxylic acids and their anhydrides.

11. The electrostatic image developing toner according to claim 8, wherein the binder resin has a glass transition point of from 40 to 90° C., a number average molecular weight (Mn) of from 1,500 to 50,000 and a weight average molecular weight (Mw) of from 10,000 to 3,000,000.

12. The electrostatic image developing toner according to claim 8, wherein the binder resin has a hydroxyl value of at most 50 and an acid value of at most 50.

13. An electrostatic image developing toner comprising at least a binder resin, a magnetic material and a charge control agent of the following formula (1) and having a saturation magnetization of from 2 to 50 Am²/kg and a coercive force of from 40 to 200 oersted: 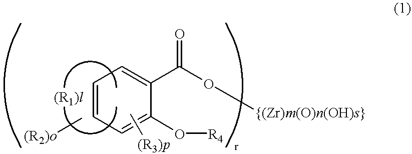
wherein R₁ is quaternary carbon, methine or methylene and may contain a hetero atom of N, S, O or P, each of R₂ and R₃ which are independent of each other, is an alkyl group, an alkenyl group, an alkoxy group, an aryl, aryloxy, aralkyl or aralkyloxy group which may have a substituent, a halogen atom, a hydrogen atom, a hydroxyl group, an amino group which may have a substituent, a carboxyl group, a carbonyl group, a nitro group, a nitroso group, a sulfonyl group or a cyano group, R₄ is a hydrogen atom or an alkyl group, l is an integer of from 0 to 12, m is an integer of from 1 to 20, n is an integer of from 0 to 20, o is an integer of from 0 to 4, p is an integer of from 0 to 4, r is an integer of from 1 to 20, and s is an integer of from 0 to 20.

14. The electrostatic image developing toner according to claim 13, wherein the binder resin is a polymer or copolymer made of a monomer selected from the group consisting of styrene type monomers, acrylic monomers and rnethacrylic monomers.

15. The electrostatic image developing toner according to claim 13, wherein the binder resin is a polyester comprising at least one alcohol component selected from the group consisting of dihydric and polyhydric alcohols and at least one acid component selected from the group consisting of dicarboxylic and polycarboxylic acids and their anhydrides.

16. The electrostatic image developing toner according to claim 13, wherein the binder resin has a glass transition point of from 40 to 90° C., a number average molecular weight (Mn) of from 1,500 to 50,000 and a weight average molecular weight (Mw) of from 10,000 to 3,000,000.

17. The electrostatic image developing toner according to claim 13, wherein the binder resin has a hydroxyl value of at most 50 and an acid value of at most 50.
